(19) United States
(12) Patent Application Publication
(10) Pub. No.: US 2026/0203484 A1
(43) Pub. Date: Jul. 16, 2026

(54) DRILL BIT OPTIMIZATION FRAMEWORK

(71) Applicant: Schlumberger Technology Corporation, Sugar Land, TX (US)

(72) Inventors: Edward Richards, Stonehouse (GB); Riadh Boualleg, Stonehouse (GB); Joshua Damian Knowles, Cambridge (GB); Michael John Williams, Cambridge (GB); Yuelin Shen, Katy, TX (US); Olga Domanova, Beijing (CN); Bo Liu, Beijing (CN); Gang Xu, Beijing (CN); Yupeng Xu, Beijing (CN); Philip G. Trunk, Houston, TX (US); James Masdea, Houston, TX (US); Ole Gjertsen, Sugar Land, TX (US)

(21) Appl. No.: 19/447,377

(22) Filed: Jan. 13, 2026

Related U.S. Application Data
(60) Provisional application No. 63/744,772, filed on Jan. 13, 2025.

(51) Int. Cl. G06F 30/28; G06F 30/12; G06F 30/17; G06F 111/06; G06F 119/18

(52) U.S. Cl. CPC G06F 30/28; G06F 30/12; G06F 30/17; G06F 2111/06; G06F 2119/18

(57) ABSTRACT

A method may include executing a computational framework to render a graphical user interface to a display that includes graphical controls for specification of bit design optimization properties for one or more formation types; executing multi-objective optimization code according to the bit design optimization properties to generate bit design genotypes; executing genotype-to-phenotype code to generate bit design phenotypes from the bit design genotypes; executing one or more simulators to generate simulation results for the bit design phenotypes; executing fitness vector generation code to generate a fitness vector for the simulation results; and executing the multi-objective optimization code using the fitness vector to generate a set of bit design genotypes.

### CROSS REFERENCE TO RELATED APPLICATIONS

This application claims priority to U.S. Provisional Patent Application No. 63/744772, which was filed on Jan. 13, 2025, and is incorporated herein by reference in its entirety.

### BACKGROUND

A resource field may be an accumulation, pool or group of pools of one or more resources (e.g., oil, gas, oil and gas) in a subsurface environment. A resource field may include at least one reservoir. A reservoir may be shaped in a manner that may trap hydrocarbons and may be covered by an impermeable or sealing rock. A bore may be drilled into an environment where the bore may be utilized to form a well that may be utilized in producing hydrocarbons from a reservoir.

A rig may be a system of components that may be operated to form a bore in an environment, to transport equipment into and out of a bore in an environment, etc. As an example, a rig may include a system that may be used to drill a bore using one or more drill bits and to acquire information about an environment, about drilling, etc. A resource field may be an onshore field, an offshore field or an on-and offshore field. A rig may include components for performing operations onshore and/or offshore. A rig may be, for example, vessel-based, offshore platform-based, onshore, etc.

Field planning may occur over one or more phases, which may include an exploration phase that aims to identify and assess an environment (e.g., a prospect, a play, etc.), which may include drilling of one or more bores (e.g., one or more exploratory wells, etc.). Other phases may include appraisal, development and production phases. During development, a rig may be utilized to support a drillstring that includes a drill bit to drill a borehole.

In various instances, drill bit selection may be a time consuming and iterative process that demands a balance between number of trial-and-error iterations and field timings. Proper drill bit selection and drilling control may provide for improved planning and drilling, which may be via one or more of reduced cost, reduced time, reduced emissions, improved borehole quality, improved drill bit utilization, etc.

### SUMMARY

A method may include executing a computational framework to render a graphical user interface to a display that includes graphical controls for specification of bit design optimization properties for one or more formation types; executing multi-objective optimization code according to the bit design optimization properties to generate bit design genotypes; executing genotype-to-phenotype code to generate bit design phenotypes from the bit design genotypes; executing one or more simulators to generate simulation results for the bit design phenotypes; executing fitness vector generation code to generate a fitness vector for the simulation results; and executing the multi-objective optimization code using the fitness vector to generate a set of bit design genotypes. Various other apparatuses, systems, methods, etc., are also disclosed.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations may be more readily understood by reference to the following description taken in conjunction with the accompanying drawings.

FIG. 1 illustrates examples of equipment in a geologic environment;

FIG. 2 illustrates examples of equipment and examples of hole types;

FIG. 3 illustrates an example of a system;

FIG. 4 illustrates an example of a drill bit;

FIG. 5 illustrates an example of a blade and examples of cutters;

FIG. 6 illustrates an example of workflow;

FIG. 7 illustrates an example of a graphical user interface;

FIG. 8 illustrates examples of components of a framework;

FIG. 9 illustrates an example of a workflow;

FIG. 10 illustrates an example of a workflow;

FIG. 11 illustrates an example of a workflow;

FIG. 12 illustrates an example of a workflow;

FIG. 13 illustrates an example of a graphical user interface;

FIG. 14 illustrates an example of a graphical user interface;

FIG. 15 illustrates an example of a graphical user interface;

FIG. 16 illustrates an example of a graphical user interface;

FIG. 17 illustrates an example of a workflow;

FIG. 18 illustrates an example of a graphical user interface;

FIG. 19 an example of a graphical user interface;

FIG. 20 an example of a graphical user interface;

FIG. 21 an example of a graphical user interface;

FIG. 22 an example of a graphical user interface;

FIG. 23 an example of a graphical user interface;

FIG. 24 an example of a graphical user interface;

FIG. 25 an example of a graphical user interface;

FIG. 26 an example of a graphical user interface;

FIG. 27 an example of a graphical user interface;

FIG. 28 an example of a graphical user interface;

FIG. 29 an example of a graphical user interface;

FIG. 30 an example of a graphical user interface;

FIG. 31 an example of a graphical user interface;

FIG. 32 an example of a graphical user interface;

FIG. 33 illustrates example results of example scenarios;

FIG. 34 illustrates an example of a method and an example of a system; and

FIG. 35 illustrates an example of computing system.

### DETAILED DESCRIPTION

The following description includes the best mode presently contemplated for practicing the described implementations. This description is not to be taken in a limiting sense, but rather is made merely for the purpose of describing the general principles of the implementations. The scope of the described implementations should be ascertained with reference to the issued claims.

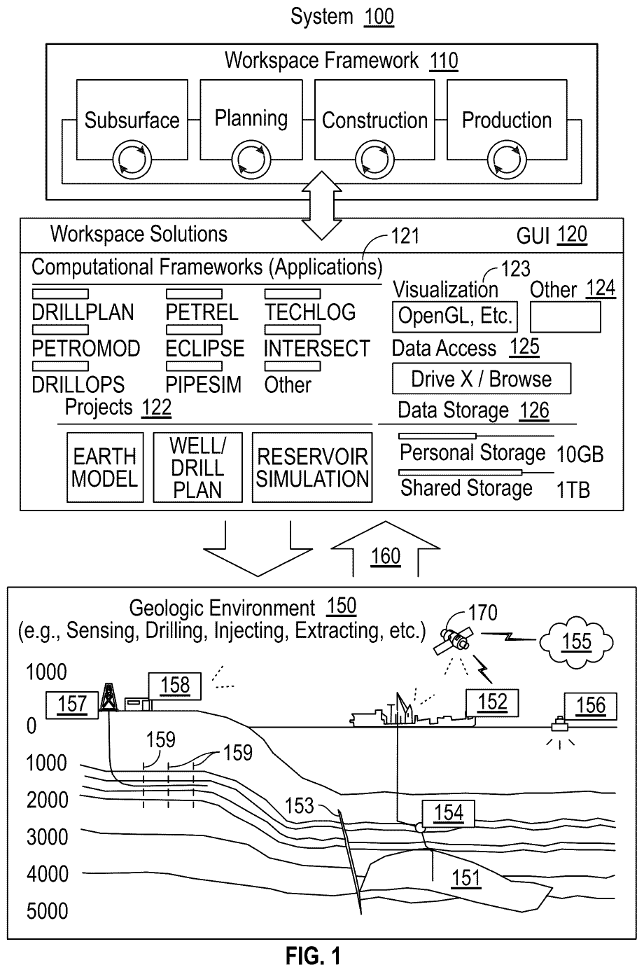

FIG. 1 shows an example of a system 100 that includes a workspace framework 110 that may provide for instantiation of, rendering of, interactions with, etc., a graphical user interface (GUI) 120. In the example of FIG. 1, the GUI 120 may include graphical controls for computational frameworks (e.g., applications, etc.) 121, projects 122, visualization features 123, one or more other features 124, data access 125, and data storage 126.

In the example of FIG. 1, the workspace framework 110 may be tailored to a particular geologic environment such as an example geologic environment 150. For example, the geologic environment 150 may include layers (e.g., stratification) that include a reservoir 151 and that may be intersected by a fault 153. As an example, the geologic environment 150 may be outfitted with a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a wellsite and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite 170 in communication with the network 155 that may be configured for communications, noting that the satellite may additionally or alternatively include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

In the example of FIG. 1, the GUI 120 shows some examples of computational frameworks, including the DRILLPLAN, DRILLOPS, PETREL, TECHLOG, PETROMOD, ECLIPSE, PIPESIM, and INTERSECT frameworks (SLB, Houston, Texas).

The DRILLPLAN framework provides for digital well construction planning and includes features for automation of repetitive tasks and validation workflows, enabling improved quality drilling programs (e.g., digital drilling plans, etc.) to be produced quickly with assured coherency.

The DRILLOPS framework may execute a digital drilling plan and ensures plan adherence, while delivering goal-based automation. The DRILLOPS framework may generate activity plans automatically individual operations, whether they are monitored and/or controlled on the rig or in town. Automation may utilize data analysis and learning systems to assist and optimize tasks, such as, for example, setting ROP to drilling a stand. A preset menu of automatable drilling tasks may be rendered, and, using data analysis and models, a plan may be executed in a manner to achieve a specified goal, where, for example, measurements may be utilized for calibration. The DRILLOPS framework provides flexibility to modify and replan activities dynamically, for example, based on a live appraisal of various factors (e.g., equipment, personnel, and supplies). Well construction activities (e.g., tripping, drilling, cementing, etc.) may be continually monitored and dynamically updated using feedback from operational activities. The DRILLOPS framework may provide for various levels of automation based on planning and/or re-planning (e.g., via the DRILLPLAN framework), feedback, etc.

The PETREL framework may be part of the DELFI environment for utilization in geosciences and geoengineering, for example, to analyze subsurface data from exploration to production of fluid from a reservoir. The DELFI cognitive exploration and production (E&P) environment (SLB, Houston, Texas), referred to herein as the DELFI environment or DELFI framework, is a secure, cognitive, cloud-based collaborative environment that integrates data and workflows with digital technologies, such as artificial intelligence and machine learning.

The PETREL framework provides components that allow for optimization of various exploration, development and production operations. The PETREL framework includes seismic to simulation software components that may output information for use in increasing reservoir performance, for example, by improving asset team productivity. Through use of such a framework, various professionals (e.g., geophysicists, geologists, and reservoir engineers) may develop collaborative workflows and integrate operations to streamline processes (e.g., with respect to one or more geologic environments, etc.). Such a framework may be considered an application (e.g., executable using one or more devices) and may be considered a data-driven application (e.g., where data is input for purposes of modeling, simulating, etc.).

The TECHLOG framework may handle and process field and laboratory data for a variety of geologic environments (e.g., deepwater exploration, shale, etc.). The TECHLOG framework may structure wellbore data for analyses, planning, etc.

The PETROMOD framework provides petroleum systems modeling capabilities that may combine one or more of seismic, well, and geological information to model the evolution of a sedimentary basin. The PETROMOD framework may predict if, and how, a reservoir has been charged with hydrocarbons, including the source and timing of hydrocarbon generation, migration routes, quantities, and hydrocarbon type in the subsurface or at surface conditions.

The ECLIPSE framework provides a reservoir simulator (e.g., as a computational framework) with numerical solutions for fast and accurate prediction of dynamic behavior for various types of reservoirs and development schemes.

The INTERSECT framework provides a high-resolution reservoir simulator for simulation of detailed geological features and quantification of uncertainties, for example, by creating accurate production scenarios and, with the integration of precise models of the surface facilities and field operations, the INTERSECT framework may produce reliable results, which may be continuously updated by real-time data exchanges (e.g., from one or more types of data acquisition equipment in the field that may acquire data during one or more types of field operations, etc.). The INTERSECT framework may provide completion configurations for complex wells where such configurations may be built in the field, may provide detailed enhanced-oil-recovery (EOR) formulations where such formulations may be implemented in the field, may analyze application of steam injection and other thermal EOR techniques for implementation in the field, advanced production controls in terms of reservoir coupling and flexible field management, and flexibility to script customized solutions for improved modeling and field management control. The INTERSECT framework, as with the other example frameworks, may be utilized as part of the DELFI environment, for example, for rapid simulation of multiple concurrent cases. For example, a workflow may utilize one or more of the DELFI environment on demand reservoir simulation features.

The aforementioned DELFI environment provides various features for workflows as to subsurface analysis, planning, construction and production, for example, as illustrated in the workspace framework 110. As shown in FIG. 1, outputs from the workspace framework 110 may be utilized for directing, controlling, etc., one or more processes in the geologic environment 150 and, feedback 160, may be received via one or more interfaces in one or more forms (e.g., acquired data as to operational conditions, equipment conditions, environment conditions, etc.).

As an example, a workflow may progress to a geology and geophysics (“G&G”) service provider, which may generate a well trajectory, which may involve execution of one or more G&G frameworks (e.g., consider the PETREL framework, etc.).

In the example of FIG. 1, the visualization features 123 may be implemented via the workspace framework 110, for example, to perform tasks as associated with one or more of subsurface regions, planning operations, constructing wells and/or surface fluid networks, and producing from a reservoir.

As an example, a visualization process may implement one or more of various features that may be suitable for one or more web applications. For example, a template may involve use of the JAVASCRIPT object notation format (JSON) and/or one or more other languages/formats. As an example, a framework may include one or more converters. For example, consider a JSON to PYTHON converter and/or a PYTHON to JSON converter. Such an approach may provide for compatibility of devices, frameworks, etc., with respect to one or more sets of instructions.

As an example, visualization features may provide for visualization of various earth models, properties, etc., in one or more dimensions. As an example, visualization features may provide for rendering of information in multiple dimensions, which may optionally include multiple resolution rendering. In such an example, information being rendered may be associated with one or more frameworks and/or one or more data stores. As an example, visualization features may include one or more control features for control of equipment, which may include, for example, field equipment that may perform one or more field operations. As an example, a workflow may utilize one or more frameworks to generate information that may be utilized to control one or more types of field equipment (e.g., drilling equipment, wireline equipment, fracturing equipment, etc.).

As to a reservoir model that may be suitable for utilization by a simulator, consider acquisition of seismic data as acquired via reflection seismology, which finds use in geophysics, for example, to estimate properties of subsurface formations. As an example, reflection seismology may provide seismic data representing waves of elastic energy (e.g., as transmitted by P-waves and S-waves, in a frequency range of approximately 1 Hz to approximately 100 Hz). Seismic data may be processed and interpreted, for example, to understand better composition, fluid content, extent and geometry of subsurface rocks. Such interpretation results may be utilized to plan, simulate, perform, etc., one or more operations for production of fluid from a reservoir (e.g., reservoir rock, etc.).

As an example, a model may be a simulated version of a geologic environment. As an example, a simulator may include features for simulating physical phenomena in a geologic environment based at least in part on a model or models. A simulator, such as a reservoir simulator, may simulate fluid flow in a geologic environment based at least in part on a model that may be generated via a framework that receives seismic data. A simulator may be a computerized system (e.g., a computing system) that may execute instructions using one or more processors to solve a system of equations that describe physical phenomena subject to various constraints. In such an example, the system of equations may be spatially defined (e.g., numerically discretized) according to a spatial model that that includes layers of rock, geobodies, etc., that have corresponding positions that may be based on interpretation of seismic and/or other data. A spatial model may be a cell-based model where cells are defined by a grid (e.g., a mesh). A cell in a cell-based model may represent a physical area or volume in a geologic environment where the cell may be assigned physical properties (e.g., permeability, fluid properties, etc.) that may be germane to one or more physical phenomena (e.g., fluid volume, fluid flow, pressure, etc.). A reservoir simulation model may be a spatial model that may be cell-based.

While several simulators are illustrated in the example of FIG. 1, one or more other simulators may be utilized, additionally or alternatively. For example, consider the VISAGE geomechanics simulator (SLB, Houston Texas) or the PIPESIM network simulator (SLB, Houston Texas), etc.

As an example, a workflow may utilize one or more types of data for one or more processes (e.g., stratigraphic modeling, basin modeling, completion designs, drilling, production, injection, etc.). As an example, one or more tools may provide data that may be used in a workflow or workflows that may implement one or more frameworks (e.g., PETREL, TECHLOG, PETROMOD, ECLIPSE, etc.).

In the example of FIG. 1, drilling may be performed in the geologic environment 150, for example, to access the reservoir 151, which may be accessed from land or offshore. In FIG. 1, the downhole equipment 154 may be, for example, part of a bottom hole assembly (BHA). The BHA may be used to drill a well. The downhole equipment 154 may communicate information to equipment at the surface, and may receive instructions and information from the equipment at the surface. During a well construction process, a variety of operations (such as cementing, wireline evaluation, testing, etc.) may be conducted. In such embodiments, data collected by tools and sensors and used for reasons such as reservoir characterization may be collected and transmitted.

A well may include a substantially horizontal portion (e.g., lateral portion) that may intersect with one or more fractures. For example, a well in a shale formation may pass through natural fractures, artificial fractures (e.g., hydraulic fractures), or a combination thereof. Such a well may be constructed using directional drilling techniques as described herein. However, these same techniques may be used in connection with other types of directional wells (such as slant wells, S-shaped wells, deep inclined wells, and others) and are not limited to horizontal wells.

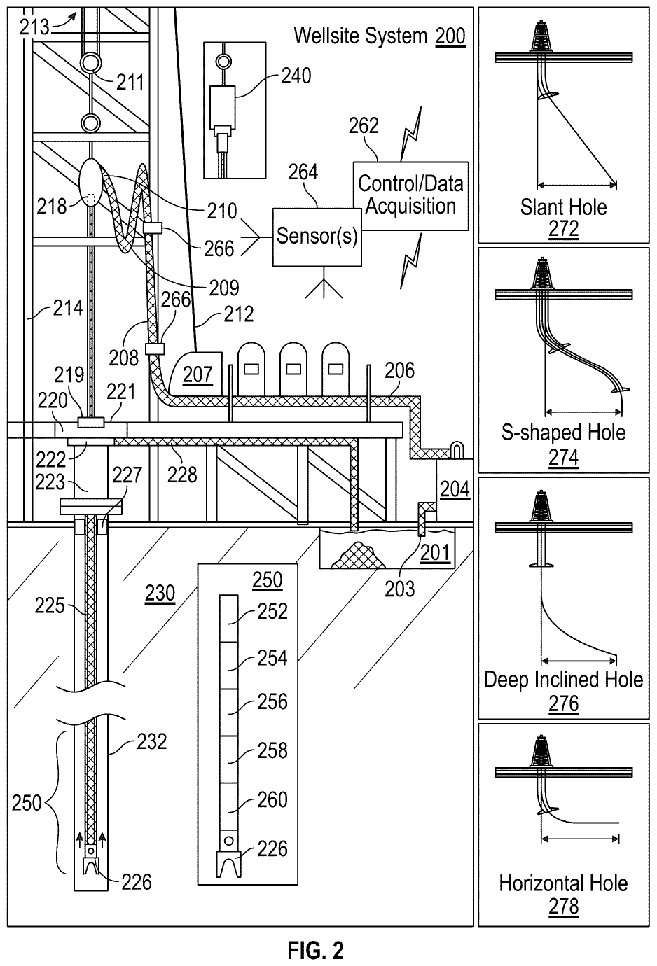

FIG. 2 shows an example of a wellsite system 200 (e.g., at a wellsite that may be onshore or offshore). As shown, the wellsite system 200 may include a mud tank 201 for holding mud and other material (e.g., where mud may be a drilling fluid), a suction line 203 that serves as an inlet to a mud pump 204 for pumping mud from the mud tank 201 such that mud flows to a vibrating hose 206, a drawworks 207 for winching drill line or drill lines 212, a standpipe 208 that receives mud from the vibrating hose 206, a kelly hose 209 that receives mud from the standpipe 208, a gooseneck or goosenecks 210, a traveling block 211, a crown block 213 for carrying the traveling block 211 via the drill line or drill lines 212, a derrick 214, a kelly 218 or a top drive 240, a kelly drive bushing 219, a rotary table 220, a drill floor 221, a bell nipple 222, one or more blowout preventors (BOPs) 223, a drillstring 225, a drill bit 226, a casing head 227 and a flow pipe 228 that carries mud and other material to, for example, the mud tank 201.

In the example system of FIG. 2, a borehole 232 is formed in subsurface formations 230 by rotary drilling; noting that various example embodiments may also use directional drilling.

As shown in the example of FIG. 2, the drillstring 225 is suspended within the borehole 232 and has a drillstring assembly 250 that includes the drill bit 226 at its lower end. As an example, the drillstring assembly 250 may be a bottom hole assembly (BHA).

The wellsite system 200 may provide for operation of the drillstring 225 and other operations. As shown, the wellsite system 200 includes the platform 211 and the derrick 214 positioned over the borehole 232. As mentioned, the wellsite system 200 may include the rotary table 220 where the drillstring 225 pass through an opening in the rotary table 220.

As shown in the example of FIG. 2, the wellsite system 200 may include the kelly 218 and associated components, etc., or a top drive 240 and associated components. As to a kelly example, the kelly 218 may be a square or hexagonal metal/alloy bar with a hole drilled therein that serves as a mud flow path. The kelly 218 may be used to transmit rotary motion from the rotary table 220 via the kelly drive bushing 219 to the drillstring 225, while allowing the drillstring 225 to be lowered or raised during rotation. The kelly 218 may pass through the kelly drive bushing 219, which may be driven by the rotary table 220. As an example, the rotary table 220 may include a master bushing that operatively couples to the kelly drive bushing 219 such that rotation of the rotary table 220 may turn the kelly drive bushing 219 and hence the kelly 218. The kelly drive bushing 219 may include an inside profile matching an outside profile (e.g., square, hexagonal, etc.) of the kelly 218; however, with slightly larger dimensions so that the kelly 218 may freely move up and down inside the kelly drive bushing 219.

As to a top drive example, the top drive 240 may provide functions performed by a kelly and a rotary table. The top drive 240 may turn the drillstring 225. As an example, the top drive 240 may include one or more motors (e.g., electric and/or hydraulic) connected with appropriate gearing to a short section of pipe called a quill, that in turn may be screwed into a saver sub or the drillstring 225 itself. The top drive 240 may be suspended from the traveling block 211, so the rotary mechanism is free to travel up and down the derrick 214. As an example, a top drive 240 may allow for drilling to be performed with more joint stands than a kelly/rotary table approach.

In the example of FIG. 2, the mud tank 201 may hold mud, which may be one or more types of drilling fluids. As an example, a wellbore may be drilled to produce fluid, inject fluid or both (e.g., hydrocarbons, minerals, water, etc.).

In the example of FIG. 2, the drillstring 225 (e.g., including one or more downhole tools) may be composed of a series of pipes threadably connected together to form a long tube with the drill bit 226 at the lower end thereof. As the drillstring 225 is advanced into a wellbore for drilling, at some point in time prior to or coincident with drilling, the mud may be pumped by the pump 204 from the mud tank 201 (e.g., or other source) via the lines 206, 208 and 209 to a port of the kelly 218 or, for example, to a port of the top drive 240. The mud may then flow via a passage (e.g., or passages) in the drillstring 225 and out of ports located on the drill bit 226 (see, e.g., a directional arrow). As the mud exits the drillstring 225 via ports in the drill bit 226, it may then circulate upwardly through an annular region between an outer surface(s) of the drillstring 225 and surrounding wall(s) (e.g., open borehole, casing, etc.), as indicated by directional arrows. In such a manner, the mud lubricates the drill bit 226 and carries heat energy (e.g., frictional or other energy) and formation cuttings to the surface where the mud (e.g., and cuttings) may be returned to the mud tank 201, for example, for recirculation (e.g., with processing to remove cuttings, etc.).

The mud pumped by the pump 204 into the drillstring 225 may, after exiting the drillstring 225, form a mudcake that lines the wellbore which, among other functions, may reduce friction between the drillstring 225 and surrounding wall(s) (e.g., borehole, casing, etc.). A reduction in friction may facilitate advancing or retracting the drillstring 225. During a drilling operation, the entire drillstring 225 may be pulled from a wellbore and optionally replaced, for example, with a new or sharpened drill bit, a smaller diameter drillstring, etc. As mentioned, the act of pulling a drillstring out of a hole or replacing it in a hole is referred to as tripping. A trip may be referred to as an upward trip or an outward trip or as a downward trip or an inward trip depending on trip direction.

As an example, consider a downward trip where upon arrival of the drill bit 226 of the drillstring 225 at a bottom of a wellbore, pumping of the mud commences to lubricate the drill bit 226 for purposes of drilling to enlarge the wellbore. As mentioned, the mud may be pumped by the pump 204 into a passage of the drillstring 225 and, upon filling of the passage, the mud may be used as a transmission medium to transmit energy, for example, energy that may encode information as in mud-pulse telemetry.

As an example, mud-pulse telemetry equipment may include a downhole device configured to effect changes in pressure in the mud to create an acoustic wave or waves upon which information may modulated. In such an example, information from downhole equipment (e.g., one or more modules of the drillstring 225) may be transmitted uphole to an uphole device, which may relay such information to other equipment for processing, control, etc.

As an example, telemetry equipment may operate via transmission of energy via the drillstring 225 itself. For example, consider a signal generator that imparts coded energy signals to the drillstring 225 and repeaters that may receive such energy and repeat it to further transmit the coded energy signals (e.g., information, etc.).

As an example, the drillstring 225 may be fitted with telemetry equipment 252 that includes a rotatable drive shaft, a turbine impeller mechanically coupled to the drive shaft such that the mud may cause the turbine impeller to rotate, a modulator rotor mechanically coupled to the drive shaft such that rotation of the turbine impeller causes said modulator rotor to rotate, a modulator stator mounted adjacent to or proximate to the modulator rotor such that rotation of the modulator rotor relative to the modulator stator creates pressure pulses in the mud, and a controllable brake for selectively braking rotation of the modulator rotor to modulate pressure pulses. In such example, an alternator may be coupled to the aforementioned drive shaft where the alternator includes at least one stator winding electrically coupled to a control circuit to selectively short the at least one stator winding to electromagnetically brake the alternator and thereby selectively brake rotation of the modulator rotor to modulate the pressure pulses in the mud.

In the example of FIG. 2, an uphole control and/or data acquisition system 262 may include circuitry to sense pressure pulses generated by telemetry equipment 252 and, for example, communicate sensed pressure pulses or information derived therefrom for process, control, etc.

The assembly 250 of the illustrated example includes a logging-while-drilling (LWD) module 254 (e.g., a LWD tool), a measuring-while-drilling (MWD) module 256 (e.g., a MWD tool), an optional module 258, a rotary steerable system (RSS), an at-bit steerable system (ABSS), and/or a motor 260, and the drill bit 226. Such components or modules may be referred to as tools where a drillstring may include a plurality of tools.

As an example, an RSS may provide for directional drilling with continuous rotation from the surface, for example, without having to utilize a slide mode (e.g., sliding mode using a mud motor, etc.). An RSS may be deployed when drilling directional, horizontal, and/or extended-reach wells. As an example, an RSS may provide for applying a relatively consistent side force (e.g., akin to a stabilizer) that rotates with a drillstring or otherwise orients a bit in a desired direction while continuously rotating at the same number of rotations per minute as the drillstring.

As an example, an ABSS may be a type of RSS. As an example, an ABSS may include a steering sleeve assembly. For example, consider a sleeve assembly that may include one or more features of an ABSS such as the NEOSTEER system (SLB, Houston, Texas). As an example, an ABSS may include an actuating system that may controllably exert pressure against a borehole wall. For example, consider a number of integrated pistons that may provide for enhancing curvature leverage within a cutting structure. In such an example, such leveraging may provide for achieving desirable build rates. An ABSS may provide for meeting curvature requirements in a curve section and directional control in a lateral section. As an example, a steering unit may incorporate metal-to-metal hydraulic seals that may help to minimize erosion and enhance hydraulic design capacity for improved performance. As an example, an ABSS may be configured within a motor-assisted BHA to provide suitable RPM levels accompanied by directional control and reliable steerability.

As an example, directional drilling may involve use of a mud motor; however, in various scenarios, a mud motor may present some challenges depending on factors such as rate of penetration (ROP), transferring weight to a bit (e.g., weight on bit, WOB) due to friction, etc. A mud motor may be a positive displacement motor (PDM) that operates to drive a bit (e.g., during directional drilling, etc.). A PDM operates as drilling fluid is pumped through it where the PDM converts hydraulic power of the drilling fluid into mechanical power to cause the bit to rotate.

As an example, a PDM may operate in a combined rotating mode where surface equipment is utilized to rotate a bit of a drillstring (e.g., a rotary table, a top drive, etc.) by rotating the entire drillstring and where drilling fluid is utilized to rotate the bit of the drillstring. In such an example, a surface RPM (SRPM) may be determined by use of the surface equipment and a downhole RPM of the mud motor may be determined using various factors related to flow of drilling fluid, mud motor type, etc. As an example, in the combined rotating mode, bit RPM may be determined or estimated as a sum of the SRPM and the mud motor RPM, assuming the SRPM and the mud motor RPM are in the same direction.

As an example, a PDM mud motor may operate in a so-called sliding mode, when the drillstring is not rotated from the surface to drive a drill bit in a particular cutting direction. In such an example, a bit RPM may be determined or estimated based on the RPM of the mud motor. As an example, during a sliding mode, oscillation of a drillstring may be provided by surface equipment, for example, to oscillate the drillstring in a clockwise and a counter-clockwise direction, which may, for example, help to reduce risk of sticking, etc.

As explained, one or more technologies may be utilized for directional drilling. Directional drilling involves drilling into the Earth to form a deviated bore such that the trajectory of the bore is not vertical; rather, the trajectory deviates from vertical along one or more portions of the bore. As an example, consider a target that is located at a lateral distance from a surface location where a rig may be stationed. In such an example, drilling may commence with a vertical portion and then deviate from vertical such that the bore is aimed at the target and, eventually, reaches the target. Directional drilling may be implemented where a target may be inaccessible from a vertical location at the surface of the Earth, where material exists in the Earth that may impede drilling or otherwise be detrimental (e.g., consider a salt dome, etc.), where a formation is laterally extensive (e.g., consider a relatively thin yet laterally extensive reservoir), where multiple bores are to be drilled from a single surface bore, where a relief well is desired, etc.

In the example of FIG. 2, the LWD module 254 may be housed in a suitable type of drill collar and may contain one or a plurality of selected types of logging tools. It will also be understood that more than one LWD and/or MWD module may be employed. Where the position of a module is mentioned, as an example, it may refer to a module at the position of the LWD module 254, the MWD module 256, etc. An LWD module may include capabilities for measuring, processing, and storing information, as well as for communicating with the surface equipment. In the illustrated example, the LWD module 254 may include a seismic measuring device.

In the example of FIG. 2, the MWD module 256 may be housed in a suitable type of drill collar and may contain one or more devices for measuring characteristics of the drillstring 225 and the drill bit 226. As an example, the MWD module 256 may include equipment for generating electrical power, for example, to power various components of the drillstring 225. As an example, the MWD module 256 may include the telemetry equipment 252, for example, where the turbine impeller may generate power by flow of the mud; it being understood that other power and/or battery systems may be employed for purposes of powering various components. As an example, the MWD module 256 may include one or more of the following types of measuring devices: a weight-on-bit measuring device, a torque measuring device, a vibration measuring device, a shock measuring device, a stick slip measuring device, a direction measuring device, and an inclination measuring device.

FIG. 2 also shows some examples of types of holes that may be drilled. For example, consider a slant hole 272, an S-shaped hole 274, a deep inclined hole 276 and a horizontal hole 278.

As an example, a drilling operation may include directional drilling where, for example, at least a portion of a well includes a curved axis. For example, consider a radius that defines curvature where an inclination with regard to the vertical may vary until reaching an angle between about 30 degrees and about 60 degrees or, for example, an angle to about 90 degrees or possibly greater than about 90 degrees.

As an example, a directional well may include several shapes where each of the shapes may aim to meet particular operational demands. As an example, a drilling process may be performed on the basis of information as and when it is relayed to a drilling engineer. As an example, inclination and/or direction may be modified based on information received during a drilling process.

As an example, deviation of a bore may be accomplished in part by use of one or more of an RSS, a downhole motor and/or a turbine. As to a motor, for example, a drillstring may include a positive displacement motor (PDM).

As an example, a system may be a steerable system and include equipment to perform a method such as geosteering. As an example, a steerable system may include a PDM or a turbine on a lower part of a drillstring which, just above a drill bit, a bent sub may be mounted. As an example, above a PDM, MWD equipment that provides real time or near real time data of interest (e.g., inclination, direction, pressure, temperature, real weight on the drill bit, torque stress, etc.) and/or LWD equipment may be installed. As to the latter, LWD equipment may make it possible to send to the surface various types of data of interest, including for example, geological data (e.g., gamma ray log, resistivity, density and sonic logs, etc.).

The coupling of sensors providing information on the course of a well trajectory, in real time or near real time, with, for example, one or more logs characterizing the formations from a geological viewpoint, may allow for implementing a geosteering method. Such a method may include navigating a subsurface environment, for example, to follow a desired route to reach a desired target or targets.

As an example, a drillstring may include an azimuthal density neutron (ADN) tool for measuring density and porosity; a MWD tool for measuring inclination, azimuth and shocks; a compensated dual resistivity (CDR) tool for measuring resistivity and gamma ray related phenomena; one or more variable gauge stabilizers; one or more bend joints; and a geosteering tool, which may include a motor and optionally equipment for measuring and/or responding to one or more of inclination, resistivity and gamma ray related phenomena.

As an example, geosteering may include intentional directional control of a wellbore based on results of downhole geological logging measurements in a manner that aims to keep a directional wellbore within a desired region, zone (e.g., a pay zone), etc. As an example, geosteering may include directing a wellbore to keep the wellbore in a particular section of a reservoir, for example, to minimize gas and/or water breakthrough and, for example, to maximize economic production from a well that includes the wellbore.

Referring again to FIG. 2, the wellsite system 200 may include one or more sensors 264 that are operatively coupled to the control and/or data acquisition system 262. As an example, a sensor or sensors may be at surface locations. As an example, a sensor or sensors may be at downhole locations. As an example, a sensor or sensors may be at one or more remote locations that are not within a distance of the order of about one hundred meters from the wellsite system 200. As an example, a sensor or sensor may be at an offset wellsite where the wellsite system 200 and the offset wellsite are in a common field (e.g., oil and/or gas field).

As an example, one or more of the sensors 264 may be provided for tracking pipe, tracking movement of at least a portion of a drillstring, etc.

As an example, the system 200 may include one or more sensors 266 that may sense and/or transmit signals to a fluid conduit such as a drilling fluid conduit (e.g., a drilling mud conduit). For example, in the system 200, the one or more sensors 266 may be operatively coupled to portions of the standpipe 208 through which mud flows. As an example, a downhole tool may generate pulses that may travel through the mud and be sensed by one or more of the one or more sensors 266. In such an example, the downhole tool may include associated circuitry such as, for example, encoding circuitry that may encode signals, for example, to reduce demands as to transmission. As an example, circuitry at the surface may include decoding circuitry to decode encoded information transmitted at least in part via mud-pulse telemetry. As an example, circuitry at the surface may include encoder circuitry and/or decoder circuitry and circuitry downhole may include encoder circuitry and/or decoder circuitry. As an example, the system 200 may include a transmitter that may generate signals that may be transmitted downhole via mud (e.g., drilling fluid) as a transmission medium.

As an example, one or more portions of a drillstring may become stuck. The term stuck may refer to one or more of varying degrees of inability to move or remove a drillstring from a bore. As an example, in a stuck condition, it might be possible to rotate pipe or lower it back into a bore or, for example, in a stuck condition, there may be an inability to move the drillstring axially in the bore, though some amount of rotation may be possible. As an example, in a stuck condition, there may be an inability to move at least a portion of the drillstring axially and rotationally.

As to the term “stuck pipe”, this term may refer to a portion of a drillstring that cannot be rotated or moved axially. As an example, a condition referred to as “differential sticking” may be a condition whereby the drillstring cannot be moved (e.g., rotated or reciprocated) along the axis of the bore. Differential sticking may occur when high-contact forces caused by low reservoir pressures, high wellbore pressures, or both, are exerted over a sufficiently large area of the drillstring. Differential sticking may have time and financial cost.

As an example, a sticking force may be a product of the differential pressure between the wellbore and the reservoir and the area that the differential pressure is acting upon. This means that a relatively low differential pressure (delta p) applied over a large working area may be just as effective in sticking pipe as may a high differential pressure applied over a small area.

As an example, a condition referred to as “mechanical sticking” may be a condition where limiting or prevention of motion of the drillstring by a mechanism other than differential pressure sticking occurs. Mechanical sticking may be caused, for example, by one or more of junk in the hole, wellbore geometry anomalies, cement, keyseats or a buildup of cuttings in the annulus.

Various types of data associated with field operations may be 1-D series data. For example, consider data as to one or more of a drilling system, downhole states, formation attributes, and surface mechanics being measured as single or multi-channel time series data.

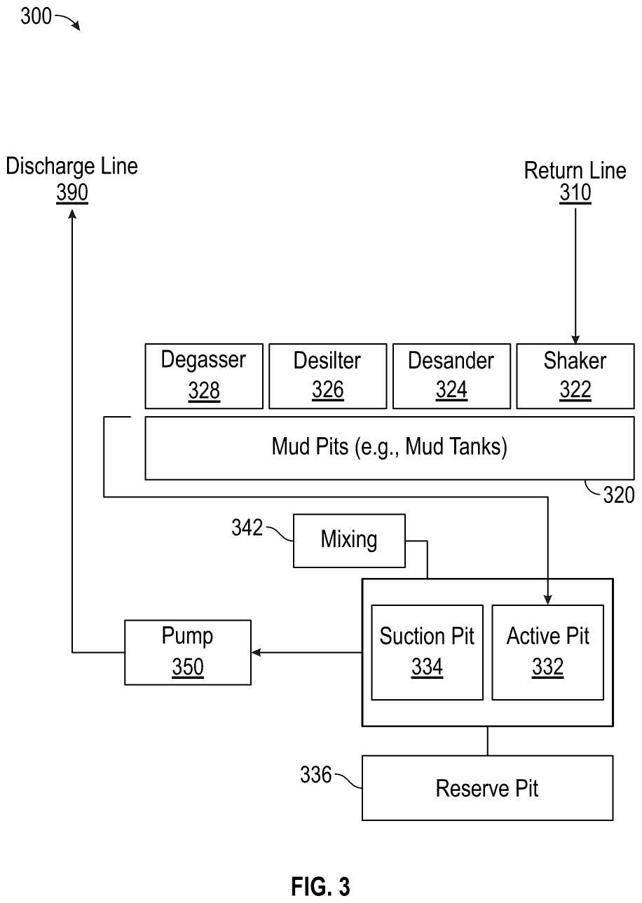

FIG. 3 shows an example of a drilling fluid system 300 that may aim to provide for various operations, which may include one or more of removing cuttings from a well, controlling formation pressures, suspending and releasing cutting, sealing permeable formations, maintaining wellbore stability, minimizing formation damage, cooling, lubricating and supporting a bit and drilling assembly, transmitting hydraulic energy to one or more downhole tools and/or a bit, ensuring adequate formation evaluation, controlling corrosion, facilitating cementing and completion, preventing gas hydrate formation, and minimizing impact on the environment.

As shown in the example of FIG. 3, the system 300 may include a return line 310 and a discharge line 390 (see also, e.g., the lines, pipes, hoses, etc., 206, 208, 209, 210, and 228 of FIG. 2). In the example of FIG. 3, the system 300 may include a shaker 322, a desander 324, a desilter 326, and a degasser 328 associated with various mud pits 320 (e.g., mud tanks) that may receive drilling fluid via the return line 310 and output processed drilling fluid to an active pit 332 that may be in fluid communication with a suction pit 334 and a reserve pit 336 where the suction pit 334 may be in fluid communication with a pump 350 that may pump drilling fluid to the discharge line 390. As an example, one or more mixing units 342 may be included, for example, for addition of one or more materials to the drilling fluid before it is pumped to the discharge line 390.

As an example, the system 300 may be utilized for one or more types of operations, which may include drilling, wireline, completions, blow out control, etc. As to completions, as an example, a cementing operation may include pumping and/or receiving of drilling fluid where cement may be positioned between casing and a borehole wall.

As an example, cuttings may be retrieved at surface, for example, using one or more of the components of the system 200 of FIG. 2, the system 300 of FIG. 3, etc. Cuttings may be produced as rock is broken by a drill bit advancing through a subsurface environment. As explained, cuttings may be carried to surface by drilling fluid (e.g., mud) circulating from one or more openings of a tool string such as, for example, openings of a drill bit of a drillstring. Drill cuttings may be separated from fluid using one or more types of equipment such as, for example, shale shakers, centrifuges, cyclone separators, etc. In cable-tool drilling, cuttings may be periodically bailed out of a bottom of a borehole. In auger drilling, cuttings may be carried to surface on auger flights.

Various different types of drill bits exist where two predominate types of drill bits are roller cone bits and fixed cutter (or rotary drag) bits. Most fixed cutter bit designs include blades angularly spaced about a bit face. The blades project radially outward from a bit body and form flow channels therebetween. Cutting elements may be grouped and mounted on several blades, for example, in radially extending rows.

Cutting elements disposed on the blades of a fixed cutter bit may be formed of extremely hard material. As an example, for a fixed cutter bit, each cutting element may include an elongate and generally cylindrical tungsten carbide substrate that is received and secured in a pocked formed in a surface of a blade. As an example, cutting elements may include a hard cutting layer of polycrystalline diamond (PCD) or other superabrasive materials such as thermally stable diamond or polycrystalline cubic boron nitride.

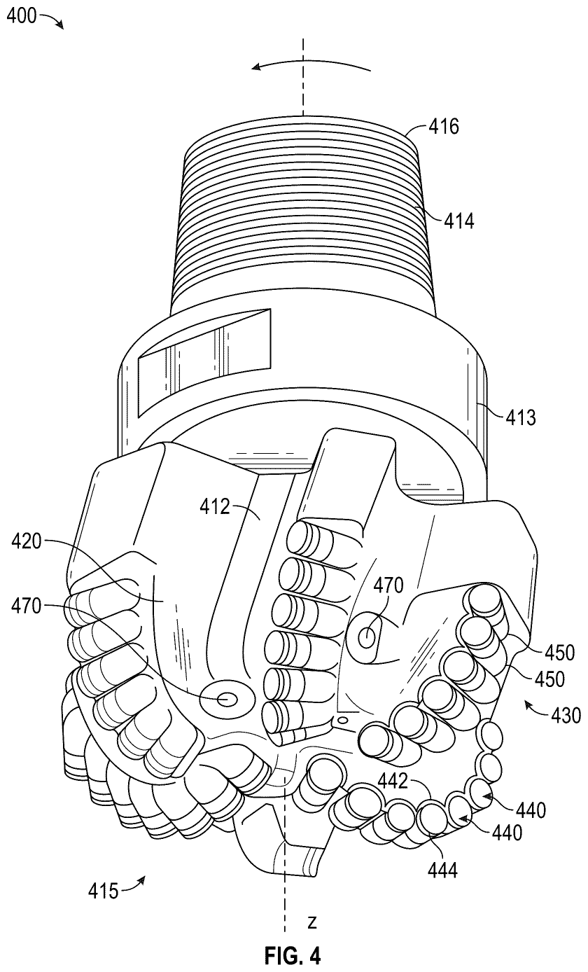

FIG. 4 shows an example of a bit 400 suitable for drilling through formations of rock to form a borehole. The bit 400 may include a bit body 412, a shank 413, and a threaded connection or pin 414 for connecting the bit 400 to a drillstring employed to rotate the bit 400 to drill a borehole. A bit face 420 may support a cutting structure 415 and be formed on an end of the bit 400 that is opposite pin end 416. The bit 400 may further be defined according to a central axis z about which bit 400 may rotate in a cutting direction represented by arrow.

As shown, the cutting structure 415 may be provided on the face 420 of bit 400. The cutting structure 415 may include angularly spaced-apart blades 430 that extend from the bit face 420. While six blades 430 are shown, the number of blades and blade types may vary (e.g., consider more or less blades, primary blades, secondary blades, etc.). As an example, a secondary blade of a bit may refer to a blade that begins at some distance from a bit axis and extends generally radially along a bit face to a periphery of the bit.

As an example, a blade may include a blade top 442 for mounting cutting elements 440. Each of the cutting elements 440 may include a respective cutting face 444. As an example, the blades 430 may include pockets 450 where each of the cutting elements 440 may be mounted in a correspond one of the pockets 450 as formed in blade tops 442. The cutting elements 440 may be arranged adjacent one another in a radially extending row proximal a leading edge of each of the blades 430.

As explained, the cutting elements 440 may be embedded in the pockets 450 of the blades 430 where the cutting elements 440 may break rock as the drill bit 400 is rotated on a bottom surface of a borehole. As explained, the cutting elements 440 may be fixed cutter elements that may include PDC or other specially manufactured cutter material.

As an example, the cutting elements 440 may be rotatable cutter elements (e.g., rotatable cutters). For example, a cutting element may include a sleeve portion where a cutting face portion is coupled to a shaft portion received by a bore of the sleeve portion. As an example, one or more cutting elements of the ENDURO 360 family of cutting elements may be utilized (SLB, Houston, Texas). A rotatable cutter may provide for reduction of mechanical and/or thermal effects that may promote wear and/or chipping of a cutter. For example, a fixed cutter is set within a pocket in a manner whereby the fixed cutter does not rotate such that a particular portion of the fixed cutter may engage a formation and wear and/or chip due to mechanical and/or thermal effects. A rotatable cutter may increase durability by help to ensure that a portion of the rotatable cutter such as an edge that makes contact with a formation is continually refreshed such that the edge may stay sharper longer. As to an edge, consider a perimeter of a cutting face that may be substantially circular and able to rotate by 360 degrees about a longitudinal axis of a rotatable cutter such that the entire perimeter may be available at times to contact rock and break the rock during drilling. As an example, rotating action of a rotatable cutter may improve thermal dissipation, which may help to reduce concentrated heat buildup. Heat buildup may occur in an asymmetric manner, which may cause heterogeneity in temperature distributions within a cutter. As a cutter may be characterized at least in part by thermal properties (e.g., thermal conductivity, coefficient of expansion, etc.), heterogeneity in temperature may increase stress or impact stress handling ability of a cutter. By rotating a cutter, heat energy caused by a portion of a cutter being a main portion interacting with rock may be dissipated as that portion rotates to a position where its interaction with rock is reduced and where another portion of the cutter rotates to become the main portion interaction with rock.

As an example, a cutter may be characterized by various dimensions such as, for example, a face dimension. As an example, a face dimension may be a diameter of a cylindrical cutter. For example, consider a diameter in a range from approximately 3 mm to approximately 30 mm or more. As to the ENDURO 360 (e.g., ENDUROBLADE 360) cutter elements, consider sizes of 13 mm, 16 mm, 19 mm, etc. As explained, a rotatable cutter may provide for increased strength and durability, which may provide for increases in run length and/or penetration rate (e.g., ROP).

As an example, a drill bit may include a number of cutters where the cutters may include fixed cutters and/or rotatable cutters. As an example, number, type and/or placement of cutters may be selected to provide desired drill bit behavior, such as, for example, improved durability in one or more high-wear areas of a drill bit.

As explained, drilling fluid (e.g., mud) may flow through passages of a drill bit to help lubricate the drill bit and to carry away cuttings. In the example of FIG. 4 the drill bit 400 is shown as including various openings 470, which may be referred to as mud ports.

In various instances, one or more types of physical phenomena may be simulated using a simulator. As an example, a simulator may be or include a drilling simulator. For example, consider one or more of the IDEAS family of simulators (IDEAS: Integrated Dynamic Engineering Analysis System, SLB, Houston, Texas). As an example, a drilling simulator may be utilized to predict downhole behavior to deal with various drilling challenges. An article by Centala et al., entitled “Bit Design—Top to Bottom”, Oilfield Review, Summer 2011:23, no. 2, is incorporated herein by reference in its entirety. The article by Centala et al., describes various aspects of simulation, including finite element analysis (FEA) simulation where an FEA mesh may be utilized to represent a modeled body such as, for example, a drillstring. The article by Centala et al., also describes a drill bit optimization system (DBOS, SLB, Houston, Texas) along with a DBOS formation characterization database that may be operatively coupled with a drilling simulation framework (e.g., IDEAS simulator, etc.). Additionally, the article by Centala et al., describes the i-DRILL engineered drilling system (SLB, Houston, Texas), which may utilize a drilling simulator (e.g., IDEAS simulator, etc.). As an example, an IDEAS simulator may utilize information in a rock file as input, which may be specific to a rock and cutter combination (e.g., formation and bit combination). As an example, a rock file may be a type of file that includes various types of information suitable for performing one or more drilling simulations using one or more drilling simulators.

As explained, a simulator may utilize information in a rock file as input, which may be specific to a rock and cutter combination (e.g., formation and bit combination). As explained, a rock file may be a type of file that includes various types of information suitable for performing one or more drilling simulations using one or more drilling simulators.

As an example, a formation model may operate using information included in a rock file or rock files. Such a file may provide for capturing bit cutter and rock interactions. A rock file may include information derived via experiments and/or field data. As an example, a rock file may be based at least in part on variations in depth, back rake (BR), and side rack (SR). As an example, a cutter may be a component of a bit that includes a number of cutters, which may be of differing size, shape and/or material. As an example, data may include operational data as to depth, BR, and SR for different cutters, and different types of rock, where confining pressure may be varied (e.g., 3000 psi, 6000 psi, 9000 psi, etc.). Output from such experiments may be organized in the form of a rock file, which may be part of a formation model. As an example, a formation model may also include properties as to tortuosity setting, damping coefficients, homogeneity or inhomogeneity, interbedded rock, inclusion rock, friction dependence on speed, rock type, etc. As to friction and speed, friction and/or types of friction may vary in a manner dependent on velocity. For example, a friction profile may be generated with respect to velocity where the friction profile may include a breakaway friction, a Stribeck friction, a Coulomb friction, a stiction friction, a viscous friction, etc. As explained, a formation may be layers in an inhomogeneous manner and/or include inclusions.

As an example, a formation model may include or be associated with a context. For example, context may include information as to trajectory, wellbore geometry, mud (drilling fluid), BHA, bit, etc. Such information may be embedded in a formation model as contextual information for purposes of simulation, for example, to restore field measurements via simulation. As an example, an inverse technique may aim to adjust one or more physical aspects of a formation model such that a suitable match is achieved between field measurements (e.g., field data) and simulation results. As a simulator may be a drilling simulator, context may provide for knowing how a scenario (e.g., drillstring, borehole, etc.) relate to a formation as characterized by physical aspects of a formation model.

As an example, a formation model may include information as to trajectory, wellbore geometry, BHA (e.g., BHA components, etc.), bit and formation. As explained, some information may be as to physical aspects of a formation and other information may be contextual.

As an example, a simulator may include or be operative coupled to a transformer. For example, consider a system that may include one or more application programming interfaces (APIs) where a simulator may issue one or more API calls and receive one or more responses in return. In such an example, a response may include information that may improve simulation results. As an example, a simulator may be part of a computational framework where a transformer may be an add-on, a plug-in, a separate component or framework, etc. As an example, a transformer may be a transformer framework that includes instructions executable by one or more processors to generate information that may be utilized in performing one or more simulations of a simulation framework.

As an example, a transformer framework may provide for various techniques that may improve simulation results. For example, consider a transformer framework that may enable an IDEAS simulator to investigate one or more additional physical parameters against cutting force. As an example, a transformer framework may provide for one or more physical parameters to be involved in, or more accurately involved in, modeling and/or simulation of bit and formation interaction. For example, consider a transformer framework that may provide for utilization of learnings from laboratory tests to be integrated into modeling and/or simulation of bit behavior during drilling. As an example, a transformer framework may enable a simulator to account for particular physical phenomena such as, for example, phenomena related to one or more of temperature, heat transfer, stress, strain, fluid dynamics, fluid properties, rock physics, etc.

As explained, a simulator may be a drilling simulator such as, for example, an IDEAS family simulator. In operation, a simulator may depend on data acquired from laboratory tests, which may aim to capture various aspects of physics of cutter-rock interaction. For example, consider information such as cutting forces curves against cutting depth and back rake angle (BR angle) and side rake angle (SR angle). For some complex field cases such as stick slip or high frequency torsional oscillation, a simulator may not necessarily include features for predictions or meaning predictions. For example, an IDEAS simulator may be unable to accurately predict actual field observation behaviors due to the lack of one or more features. In such an example, consider a lack of features that may account for physics related to one or more of speed effect, rock shape effect, rolling angle effect and chipping effect.

As an example, a transformer framework may provide a simulation framework with an ability to add one or more features. For example, consider a simulation framework that may include an ability to operate using a plug-in mechanism that may enable one or more features. For example, consider an approach where one or more user selected functions, user selected data lists, user selected subroutines may be accessed to extend a simulator to account for one or more additional physical parameters that may affect cutting forces. As an example, one or more models may be calibrated using laboratory test data and validated using data from one or more field applications. As an example, a validated model may be linked to or integrated into a simulation framework, for example, to leverage native prediction capabilities of the simulation framework. In various instances, a simulation framework such as, for example, the IDEAS framework, may provide for native prediction capabilities that may be extended and/or otherwise improved via a transformer framework. As an example, where one or more transformer framework features demonstrate sufficient drilling simulation utility, such one or more features may be integrated into a simulation framework.

As an example, a drilling simulator may depend on cutter-rock laboratory tests and, for example, interpolation thereof, to predict bit behavior and/or drillstring behavior. As an example, a transformer framework may provide for transforming a model in one or more manners. For example, consider a transformer framework that may provide for transforming a cutter-rock model usable by one or more simulators such that simulation may account for more detailed physics.

As explained, an API, add-on, plug-in, etc., approach may be utilized for linking a transformer framework to a simulation framework. In such examples, a simulation framework may be suitably modified or provided with one or more interactive mechanisms, which, for example, may provide for extending simulation capabilities. For example, consider an ability to enable expert users to prototype one or more advanced cutter-rock models. In such an example, a model or models may account for one or more of speed effect, rock shape effect, rolling angle effect, and chipping effect.

As an example, a transformer framework may provide for discovery of one or more types of physical phenomena germane to one or more drilling scenarios. For example, consider an ability to include one or more aspects of advanced physics that extend beyond native physics of a drilling simulator. In such an example, a transformer framework may provide for discovery and validation of advanced physics where, for example, relevance of advanced physics may be validated against laboratory and/or field data (e.g., as to cutting, behaviors, etc.). As an example, a transformer framework may provide for effectively embedding one or more advanced physics models into a drilling simulator, which may leverage native simulation techniques to enhance prediction accuracy of simulation results. In such an approach, a workflow may provide for improving one or more of drilling equipment, drilling plans, drilling operations, drilling performance, mitigation of one or more types of risks, etc. As an example, a transformer framework may be included in a system such as, for example, the system 100 of FIG. 1. In such an example, consider utilization of a drilling simulation framework and a transformer framework for one or more of planning, field operations control, energy utilization, emissions control, etc. As an example, a drilling simulation framework and a transformer framework may be utilized by a drill bit design and/or a drill bit cutter framework.

As an example, a transformer approach may provide for extensibility and/or flexibility as to one or more aspects of a multi-objective optimization (MOO) framework. For example, upon receipt of set up information for a MOO, a simulator may be appropriately configured to provide for one or more objectives (e.g., objective parameters, etc.) for one or more formation types that a drill bit may encounter. In such an example, a simulator may be dynamically configured responsive to input received via a GUI, etc.

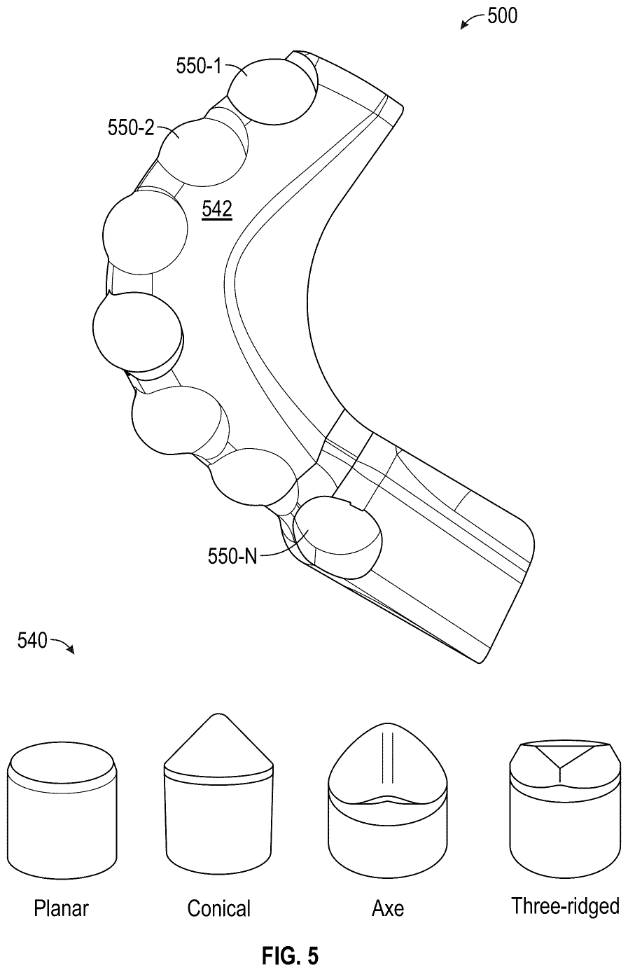

FIG. 5 shows a perspective view of an example of a blade 500 that may be part of a drill bit where the blade 500 includes a blade top 542 with a number of pockets 550-1, 550-2, . . . , 550-N. While the blade 500 includes seven pockets, a blade may include a lesser or a greater number of pockets.

As an example, one or more types of cutters may be utilized. For example, consider an assembly process that includes selecting one or more types of cutters and seating cutters of selected type or types in pockets of a blade. FIG. 5 shows some examples of cutters 540, which may include a planar cutter, a conical cutter, an axe cutter, a three-ridged cutter, etc. As shown, a cutter may be designed with a particular shape where the cutter and rock interactions may depend at least in part on shape.

As an example, a framework may provide for multi-objective optimization-based bit design. In such an example, the framework may provide for design of new drill bits and continuous improvement and automation of one or more design processes. In such an example, utilization of multi-objective optimization and generative AI may provide for exploration of various bit designs and uncovering a Pareto dominant set of bit designs, for example, through guided definition of feature descriptions and fitness vectors, and set reduction techniques to identify a bit designer's preference. As an example, a framework may be an improved computational framework that may improve on existing approaches that rely on design heuristics limited to those within designer experience where ad hoc trials are performed using a bit simulator without formal capability to improve and further automate such a process over time.

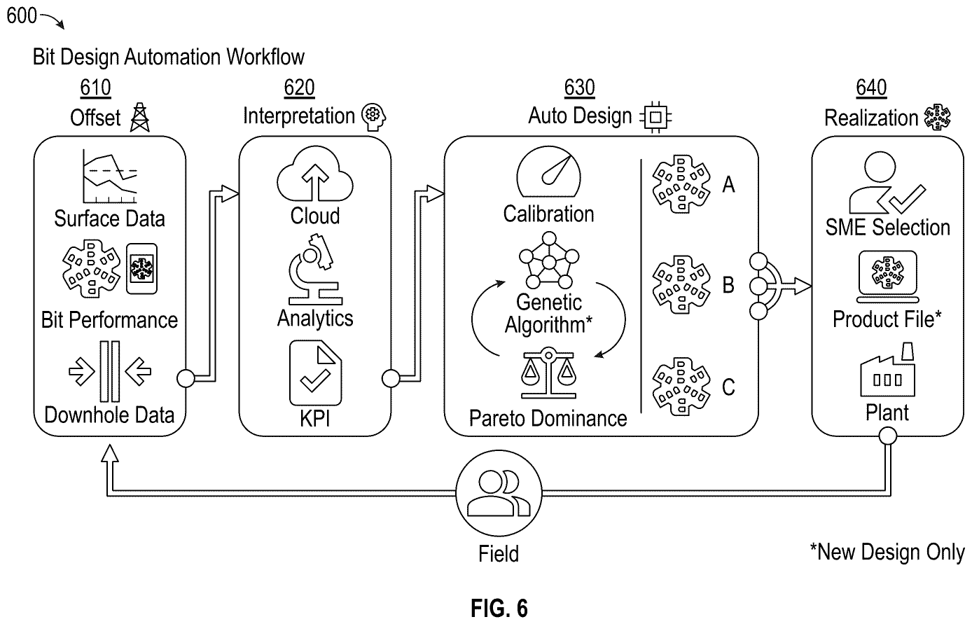

FIG. 6 shows an example of a bit design automation workflow 600 that may be implemented by a computational framework. As shown, the workflow 600 may include an offset block 610 for accessing offset well data as to surface equipment, bit performance, and downhole data as to one or more downhole tools that may be utilized during drilling. As shown, the workflow 600 may include an interpretation block 620 that may provide for access to cloud platform-based resources, analytics, performance indicators (e.g., KPIs, etc.). As shown, the workflow 600 may include an automated design block 630 that may provide for generation of various bit designs via calibration, one or more genetic algorithms (e.g., “GAs” and/or one or more other evolutionary algorithms that may mimic evolution to improve a population of potential solutions over time, etc.) and one or more Pareto type of techniques (e.g., Pareto dominance, etc.). As shown, the workflow 600 may include a realization block 640 for subject matter expert (SME) interactions (e.g., via GUIs, APIs, etc.), output of a digital product file (e.g., CAD, machine-readable, three-dimensional manufacturing, etc.), a plant output, field output, etc. As shown, data acquired in the field during implementational of a bit, as designed, may be utilized in the workflow 600, for example, as data that may provide for improvement of the workflow 600. As an example, a framework may provide for guiding a bit designer in the creation of a multi-objective optimization (MOO) problem.

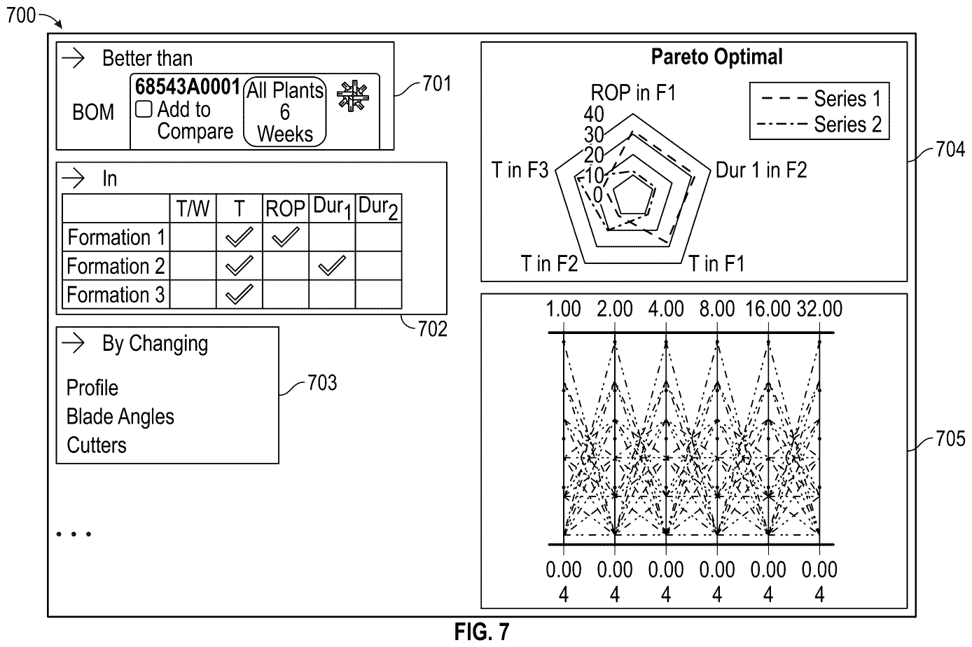

FIG. 7 shows an example of a block diagram of a graphical user interface (GUI) 700 that includes various elements. The block diagram of the GUI 700 shows various GUI elements, etc., to support guided creation of features for MOO and set reduction of results. As an example, the GUI 700 may be one or more GUIs and may be generated and interactive via a computational framework. In the example of FIG. 7, the GUI 700 may be utilized as part of a multi-objective optimization problem to be solved, for example, using an evolutionary genetic algorithm. For example, as to element 701, a bit designer may select an existing bit to be improved. The following is an example of a workflow from the bit designer's perspective. One or more base bits, per the element 701, are selected from an existing bit catalog via its BOM (bill of materials) as representing the target performance to be improved on. Per an input element 702, input may come from a rock calibration workflow where a view can be generated and presented to a bit designer to allows a designer, for example, to check boxes corresponding to properties against which bit designs may be optimized. As shown, an element 103 may provide for controllable variable selection, for example, as presented from a design file of a base bit (see element 701) and allow for selection of aspects of bit design to be varied in an optimization. In various instances, baseline performance for a base bit may be created by simulating that bit in a suitable bit simulator (e.g., IDEAS framework, etc.) using rock properties captured in a rock calibration workflow.

Upon completion of an optimization process, a bit designer may interact with a framework GUI, for example, to select from a Pareto dominant set of bits using one or more set reduction techniques. As an example, such a GUI may provide for rendering graphical controls, for example, as to filters, drop-downs, other interaction techniques, etc. As shown, the GUI 700 can provide for views including objectives defined via the element 702 using ticked items, such as, for example, a radar plot element 704 and/or in views containing potentially all items in an objective selection view per the element 702, such as parallel plots per an element 705. As an example, results may be presented in elements 704 and 705 that may also contain performance of an original base bit per the element 701. As an example, the GUI 700 may be dynamically interactive, for example, via interaction with the element 702, various other elements may be dynamically updated (e.g., dynamically revised and rendered).

As to the element 702, it may include a table of selectable items for one or more types of formations that may be germane to a particular borehole to be drilled or being drilled. As shown, items may include T/W, T, ROP, Dur₁, Dur₂, etc., which may be set on a formation-by-formation basis. As shown, the element 704 may include a spider plot where vertexes on axes correspond to selected items in the element 702, which may be specific for one or more formation types. In such an example, the spider plot may include data for the base bit design and for an optimal bit design for purposes of comparison. As explained, a Pareto approach may be implemented.

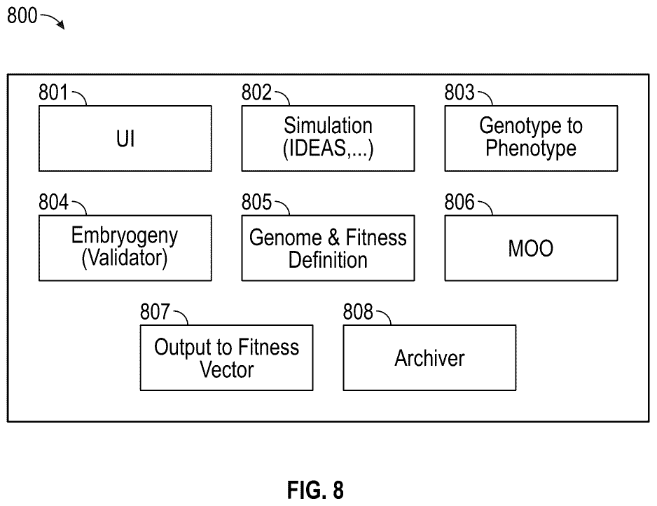

FIG. 8 shows a block diagram of various example framework components 800. As explained, a framework may have a flexible architecture to allow continuous improvement and automation. To support continuous improvement, consider a framework that includes the components 800 of FIG. 8. As shown, the components may include a UI component 801 (e.g., for human-machine and/or machine-machine interactions). As shown, a simulation component 802 may provide for use of one or more of different simulation engines, such as, for example, an IDEAS static simulator, an IDEAS dynamic simulator, a computational fluid dynamics (CFD) simulator for hydraulics, etc., which may be interchangeable such that the simulation component 702 allows for additional and multiple simulations, including distributed parallel simulations, etc. Such an approach may provide for separation and isolation of simulation from operation of MOO, per the MOO component 806.

As an example, a framework may provide for compatibility of a representation used by the MOO component 806 to a representation that is compatible with the simulation component 702. For example, consider a genotype to phenotype component 803 where a genotype representation is used by the MOO component 806 and a corresponding phenotype representation is used by the simulation component 802. The component 803 may be a translation and/or transformation type of component, which may provide for unidirectional or bidirectional operation. As an example, the component 803 may be extensible to handle various types of evolutionary algorithms and/or various types of simulators.

As an MOO may lack direct knowledge representation of bit designs (e.g., operating on a genotype rather than a phenotype), it is possible that the MOO may create bit designs that may possibly not be amenable to practical manufacture. To address such a concern, an embryogeny component 804 (e.g., a validator, etc.) may be included, which may validate whether or not a specific bit design is practically feasible. Inclusion of the component 804 may allow for a variety of possible uses of the information about feasibility by the MOO component 806.

As an example, information from the UI component 801 may be collated and converted by a genome and fitness definition component 805 into definitions of a genome vector and a fitness vector of the MOO component 806.

As shown, an output to fitness vector component 807 may provide for receipt of output file(s) from one or more simulators of the component 802 and provide for extraction of the information as appropriate for a fitness vector, applying one or more combinations and/or computations, as appropriate, to summarize some or all of the simulation outputs.

As shown, an archiver component 808 may be included for storing genomes with simulation results such that a Pareto optimal set may be explored, for example, in a final design selection operation.

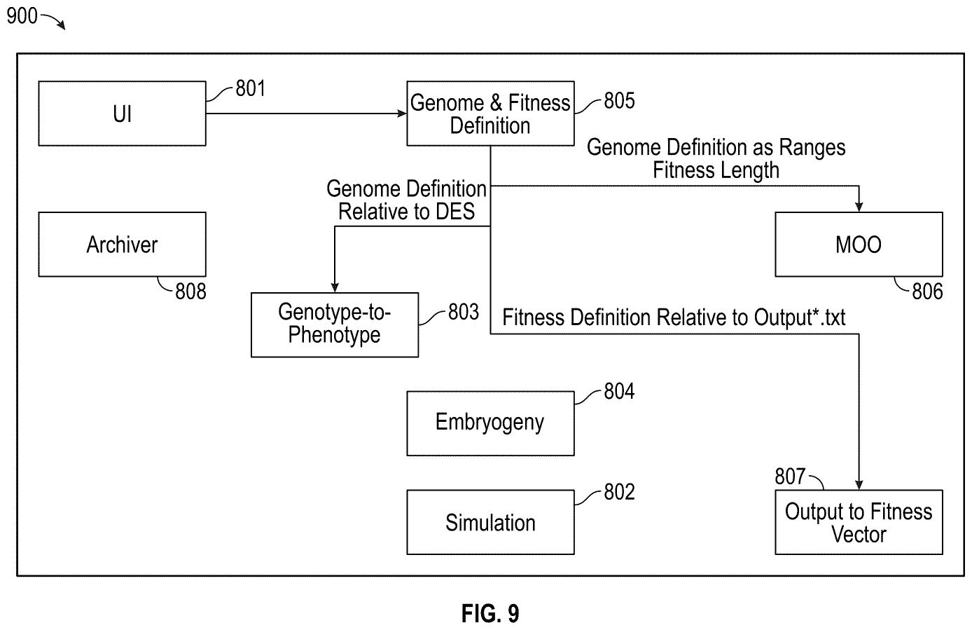

FIG. 9 shows an example of a workflow 900 for operation of a framework during an initialization phase. As an example, a framework may have different configurations during different phases of its operation. In an initialization phase, a bit designer may first set up a preferred problem to solve. UI information from the component 801 may be passed to the genome and fitness definition component 805 where it may be separated into a definition of the genome relative to a file format that describes a bit for manufacture (e.g., a DES format). This definition may be transmitted to the genotype-to-phenotype component 803 which may then be configured to perform a mapping from one to the other during an optimization phase. In such an approach, the definition of the genome itself, together with the ranges on its inputs, may form part of a configuration of the MOO component 806. Another aspect of configuring the MOO component 806 may include determining a length of a fitness vector, which can correspond to a number of objectives being optimized simultaneously. As an example, mapping may be performed to populate a requested definition of a fitness vector from output of one or more simulators that may be sent to the output to fitness vector component 807, which can provide such a service during an optimization phase.

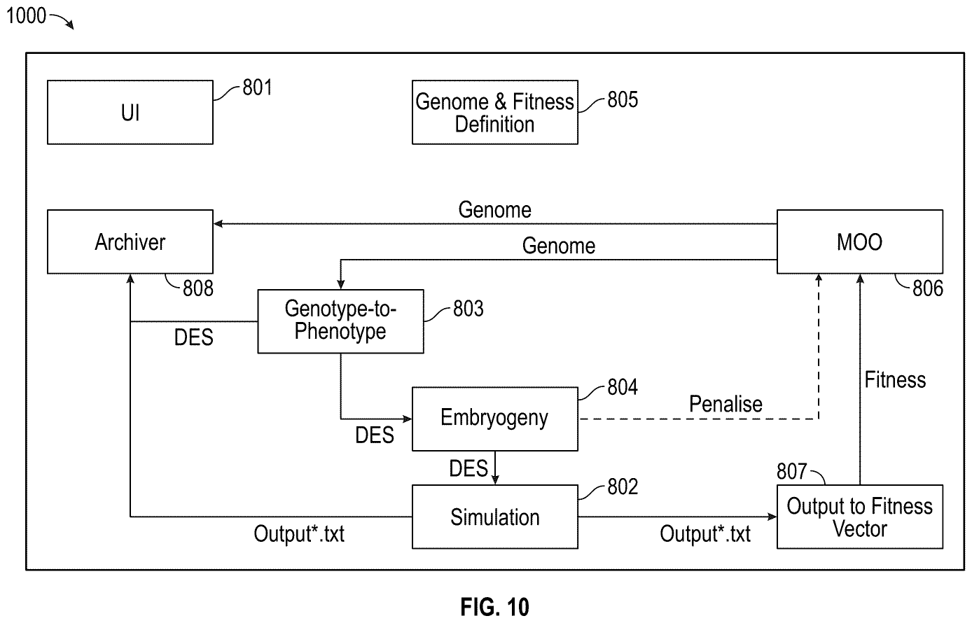

FIG. 10 shows an example workflow 1000 of a framework during an optimization phase. During an optimization phase, a generation of genomes may be created by the MOO component 806. This generation may be transmitted to both the archiver component 808 and for conversion to bit designs (DES files) by the genotype-to-phenotype component 803. Once converted, the bit design (DES) may also be transmitted to the archiver component 808 and the genome and DES may be linked. The DES file may then be transmitted to the embryogeny component 804 for validation. In such an approach, a penalty may result and be attached to this genome at the MOO component 806. As an example, a DES file may be submitted for simulation per the simulation component 802, where there may be a number of simulations performed to explore different aspects of bit performance. In such an example, results from the number of simulations may be consolidated in an output *.txt file which may then be archived per the archiver component 808, where it may be linked to a corresponding DES file and genome, and, for example, converted to a fitness vector by the component 807, which may be shared to the MOO component 806.

As an example, the MOO component 806 may process genomes, fitness vectors and one or more types of penalty information, if present, to create a next generation of genomes. Such a process may be iterative and repeatable in a looped manner, for example, developing Pareto dominant genes using the MOO component 806, and resulting in such genes being linked to bit design DES files and simulation output *.txt files in the archiver component 808.

As an example, a framework may provide for choice of MOO implemented by the MOO component 806 to be changed as desired without impacting framework operation. In such an example, the framework may allow for development of more sophisticated simulation per the component 802, for example, depending on available compute and advances in simulation technology. In such a manner, the goal of a continuous improvement may be met by modularity chosen for a design.

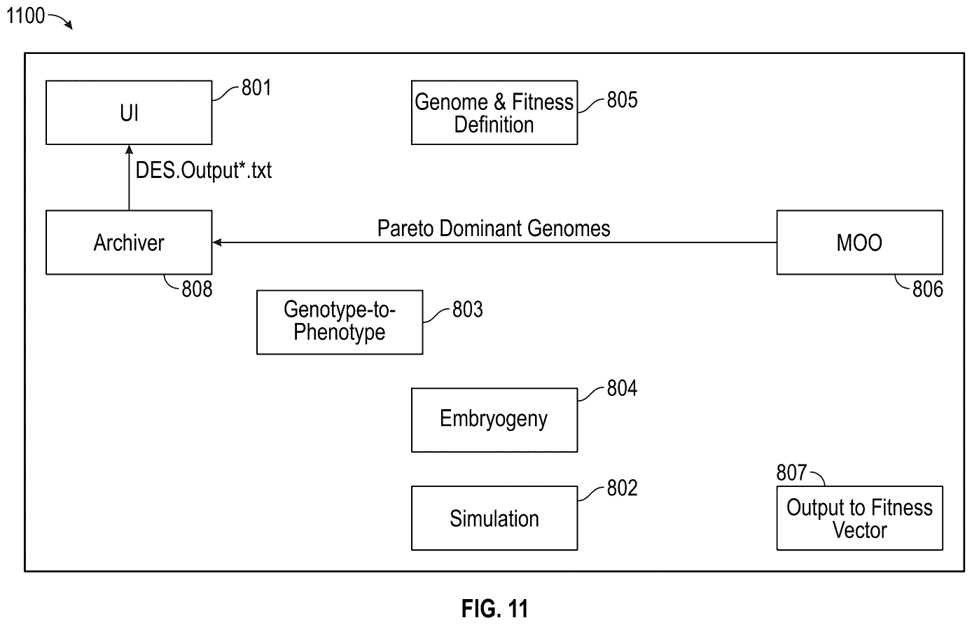

FIG. 11 shows an example workflow 1100 of a framework for operation during a design choice phase. In such an example, once a set of Pareto dominant genomes has been determined by the MOO component 806, the archiver component 808 may be informed of this set and the UI component 801 may be used to make selections against that set using one or more interactive set reduction techniques. As an example, the UI component 801 may provide a bit designer access to various aspects of a design via information from a DES file and an output *.txt file such that operation is not necessarily restricted to the information of either the genome or fitness vector definitions.

Although portrayed sequentially for illustration, a design choice phase may occur at one or more of different stages of an optimization phase, for example, for purposes of user preference modelling which may then be used for advanced automation of the optimization phase.

As explained, a framework may provide for genome generation and output of a particular digital file, for example, consider a DES file. As explained, an embryogeny component may receive a DES file for purposes of evaluation as to practical manufacturability. Such a component may generate one or more validation concerns and/or may output an indication of practical manufacturability or no practical manufacturability. As an example, a framework may provide for implementation of one or more penalization techniques based on how manufacturable a generated bit design or bit designs are, which may provide for broadening of an exploration space for design. For example, if limited to conventional designs with respect to manufacturability, a risk may exist as to limitations that hinder revolutionary designs. As an example, where revolutionary designs may be desirable, flexibility may be provided as to embryogeny and associated validation and/or assessment. As an example, a human-in-the-loop (HITL) approach may be utilized to assess designs that may be considered revolutionary to determine whether or not manufacturing of such designs may be practical (e.g., via existing equipment, modification of existing equipment, etc.).

As explained, simulations may be performed using DES files and rock files, for example, to generate results that may be output using a particular file formation, which may, for example, be a text format. As explained, one or more types of simulators may be employed, which may execute in parallel, in series, in parallel and in series, etc. As explained, a simulator may be a drilling simulator that may provide for static and/or dynamic simulations. As explained, a simulator may be a CFD simulator that may provide for simulation of fluid dynamics as may be associated with flow of drilling fluid. As explained, a drillstring may include a mud motor, which may be driven by flow of drilling fluid. As explained, a bit may include openings for flow of drilling fluid, which may provide for lubrication, etc. As explained, drilling fluid may provide for removal of cuttings from bit and formation interactions as a bit may crush (e.g., break) rock.

As explained, output from simulation may be a file that may be utilized to generate a fitness vector for utilization by MOO. As an example, generation of a fitness vector may be configurable, for example, using a fitness vector definition as may be controlled via one or more GUIs. As explained, a GUI may provide for selecting one or more aspects of performance with respect to one or more formations. In such an example, a fitness vector definition may be generated, which may be dynamically generated via one or more UI interactions, which may be human-machine and/or machine-machine. As explained, one or more GUI elements may be automatically revised and rendered responsive to one or more interactions.

As an example, MOO may implement a library such as, for example, the pymoo library. The pymoo library provides a computational framework with stored code offering state of the art single-and multi-objective optimization algorithms and other features related to multi-objective optimization such as visualization and decision making. The pymoo library is available on PyPi. As to some examples of MOO algorithms, consider GA, differential evolution, biased random key GA, nelder Mead, pattern search, CMAES, evolutionary strategy, stochastic ranking evolutionary strategy, improved stochastic ranking evolutionary strategy, NSGA-II, R-NSGA-II, NSGA-III, R-NSGA-III, MOEAD, AGE-MOEAD, C-TAEA, SMS-EMOA, RVEA, MO-CMA-ES, etc. As an example, a framework may provide for hyperparameter tuning, which may be performed in an automated manner. As an example, a multi-run approach may be implemented to optimize hyperparameters.

As explained, a workflow may include: 1. input, starting DES, parameter and variation ranges; 2. genome based on parameters and variation ranges; 3. genotype to and from phenotype mapping and translate design parameter space to gene space and define variation ranges; 4. validator, check if a gene is viable; 5. evaluation/simulation using DES for each instance; 6. output vector from simulation results (e.g., for MOO, for use in pymoo, etc.); 7. MOO main iterations; 8. results visualization (UI); 9. selection; and 10. manufacture.

As an example, hypervolume maximization may be implemented as part of a workflow. An article by Hochstrate (Baume) et al., entitled “SMS-EMOA: Multiobjective selection based on dominated hypervolume”, February 2007, European Journal of Operational Research 181(3):1653-1669 (DOI:10.1016/j.ejor.2006.08.008), is incorporated by reference herein. Another article by Knowles et al., entitle “Bounded archiving using the lebesgue measure,” The 2003 Congress on Evolutionary Computation, 2003. CEC '03., Canberra, ACT, Australia, 2003, pp. 2490-2497 Vol. 4 (doi: 10.1109/CEC.2003.1299401) is incorporated by reference herein.

An article by Li et al., entitled, “Multi-Objective Archiving”, March 2023, (DOI:10.48550/arXiv.2303.09685) is incorporated by reference herein, which provides a survey. As an example, an issue may arise for optimizing three and more objectives simultaneously such that a wide diversity of Pareto optimal solutions/bits may be found (e.g., trade-offs of the objectives, etc.). To constrain such a set such that it does not grow enormously large, a filter-based approach may be applied, which may be dynamically applied (e.g., as solutions are found, etc.). In such an example, a method may abide by the ordering of solutions imposed by Pareto optimality. As an example, one or more of various schemes may be applied such that suitable diversity is maintained while, for example, achieving monotonic progress (e.g., not going backwards).

As to embryogeny, this may mean that an indirect encoding of bit designs may be applied such that a separate “growth” process is used in which a framework may check for constraints and/or one or more other types of violations and/or one or more other factors so that for an encoded bit, which may initially be infeasible, it may be grown to be feasible. An article by Yogev et al., entitled “Computational Evolutionary Embryogeny,” in IEEE Transactions on Evolutionary Computation, vol. 14, no. 2, pp. 301-325, April 2010, (doi: 10.1109/TEVC.2009.2030438) is incorporated by reference herein.

As an example, a framework may provide smart logic between MOO and simulation (e.g., static IDEAS, dynamic IDEAS, CFD hydraulics, proxy, etc.). As an example, a framework may operate to reduce simulation demand, as appropriate, for example, to not utilize computationally expensive simulation on each design (e.g., consider a smart simulator selection). As an example, a framework may provide for a final confirmation using a relatively computationally expensive simulation on a few selected candidates. As an example, a framework may provide for an assessment of performance indicators. For example, one or more may be evaluated more often than one or more others. As an example, a framework may provide for automated and dynamic evaluation of performance indicators.

As explained, a framework may provide for relatively early rejection of a candidate design if it is found to be suboptimal by considering one or more performance indicators. As an example, one or more performance indicators may be selected, automatically, semi-automatically, manually, etc., which may occur in a dynamic manner. As an example, a set of performance indicators may be evaluated for an ability to assess designs where such a set, itself, may be dynamically honed down as an optimization workflow proceeds.

The following articles are incorporated by reference herein: Allmendinger et al., “Hang On a Minute: Investigations on the Effects of Delayed Objective Functions in Multiobjective Optimization”, March 2013, Lecture Notes in Computer Science 7811:6-20 (DOI:10.1007/978-3-642-37140-0_5); and Allmendinger, R., Knowles, J. (2023), “Heterogeneous Objectives: State-of-the-Art and Future Research”, in: Brockhoff, D., Emmerich, M., Naujoks, B., Purshouse, R. (eds) Many-Criteria Optimization and Decision Analysis, Natural Computing Series. Springer, Cham. (https://doi.org/10.1007/978-3-031-25263-1_12).

As an example, a framework may utilize one or more digital files, which may include one or more rock files. As an example, a model armory may be accessible and include information as to formation models (e.g., basin inverted formation models, etc.), which may also include performance indicator profiles of various bit designs (e.g., BOMs). As an example, a framework may provide for use of Pareto-based EMO algorithm integration to optimize cutter rake for efficiency, ROP, etc. As an example, cutter comparisons may be utilized for durability and efficiency performance indicator enrichment.

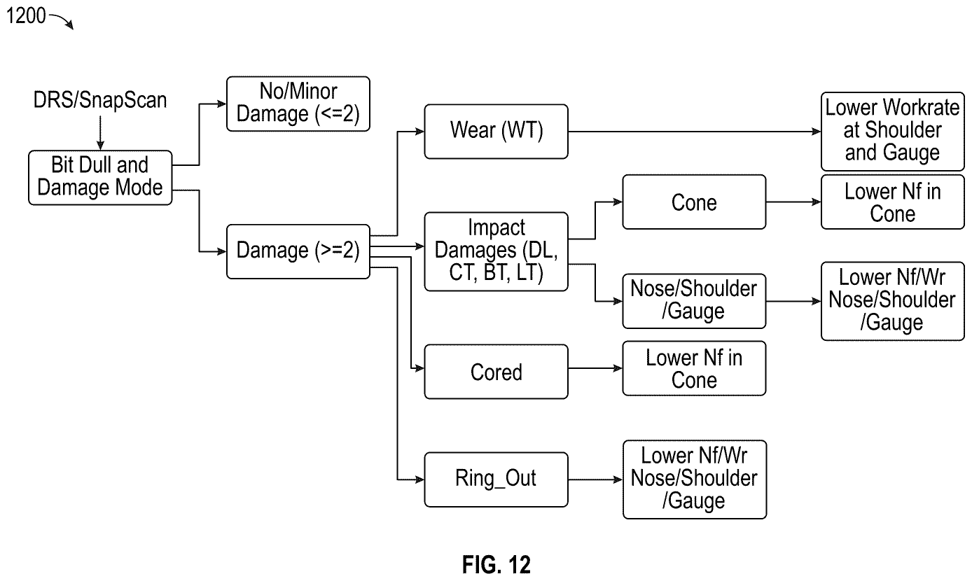

FIG. 12 shows an example of a workflow 1200 as associated with bit dull and damage mode. As shown, such a workflow may provide for assessment of various aspects of bit design.

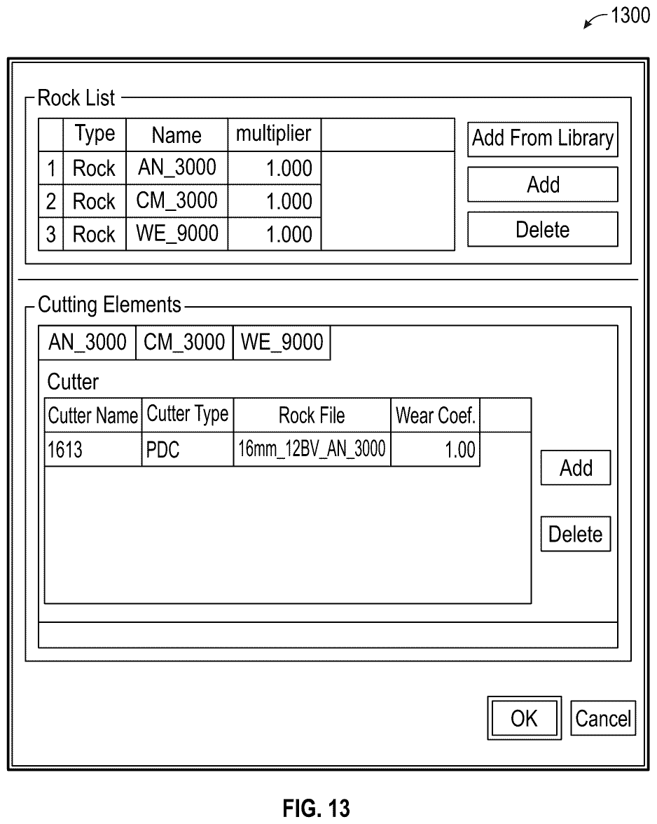

FIG. 13 shows an example GUI 1300 where rock types may be specified, along with rock multipliers and cutting elements for each rock type along with wear coefficients, etc. As shown, a rock file may be specified, which may be calibrated, etc., and utilized by one or more simulators.

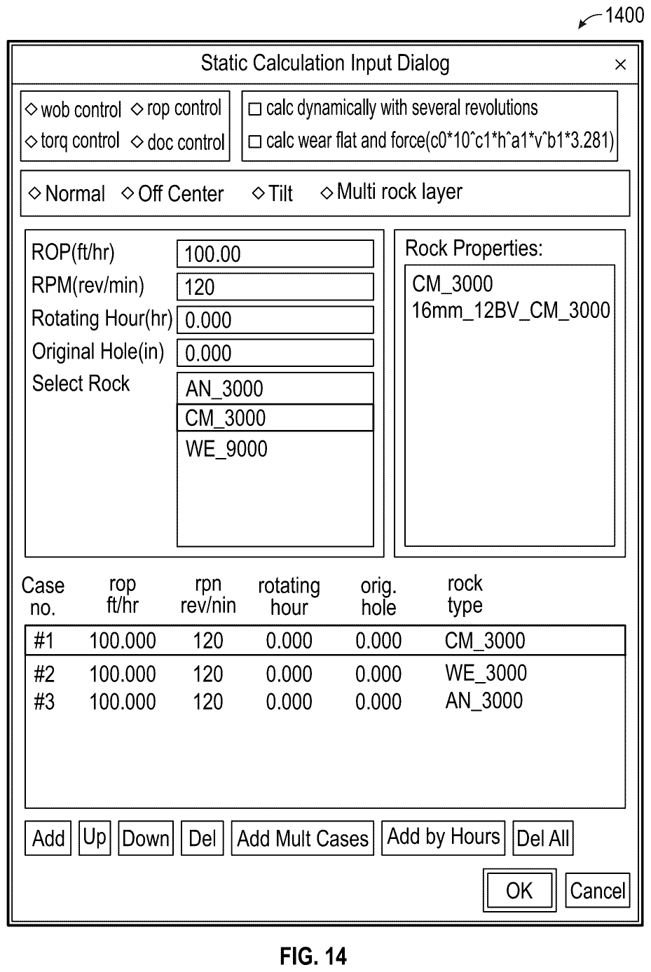

FIG. 14 shows an example GUI 1400 for static simulations for various cases, where rock type may be selected. As shown, WOB control, ROP control DOC control, torque control, etc., may be selected. As an example, such control information may be stored in association with a result such that the control information may be utilized during drilling.

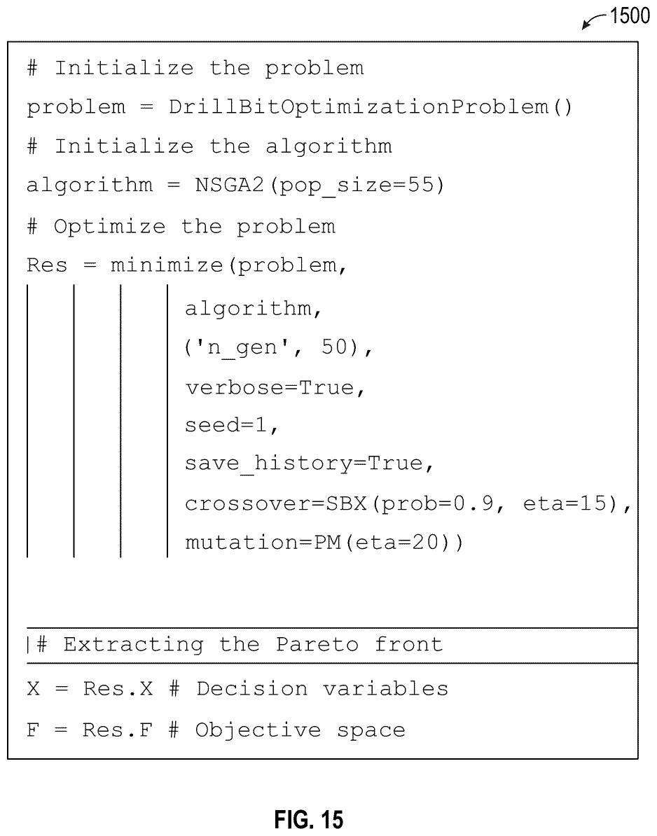

FIG. 15 shows an example GUI 1500 where example code is rendered for execution of an evolutionary algorithm (e.g., NSGA-II or NSGA2) with a population size of 55, along with various parameters set, where results may provide for extraction of a Pareto front.

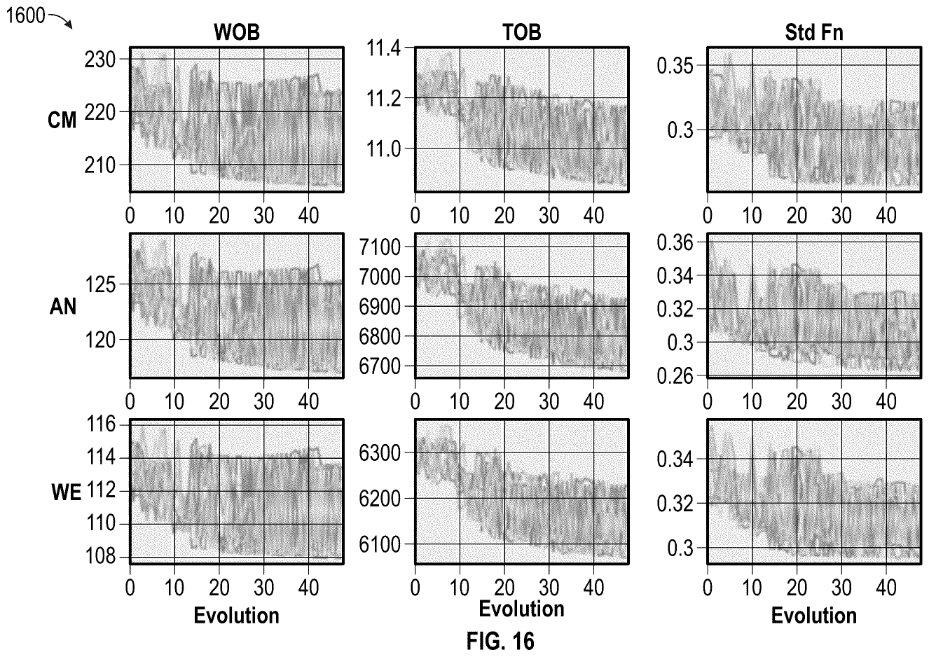

FIG. 16 shows an example GUI 1600 that includes results from execution of the code in the GUI 1500. As shown, results may be for different types of controls (e.g., WOB, TOB, etc.) and with respect to different formation types.

As to bit design, concerns may be for one or more of product quality, manufacturing time, manufacturing cost, bit design time, bit design engineering, and product performance. As an example, a framework may provide for considering one or more of such concerns. For example, consider an approach that can handle product performance and manufacturing concerns to arrive at an optimal bit design.

As mentioned, manufacturing concerns can include manufacturing time, which may be related to appropriate file generation. In various instances, a relatively minor change in bit design may introduce considerable delay in manufacture. As an example, an evolutionary approach to bit design may reduce risks as to having to make one or more relatively minor changes. For example, an evolutionary approach may account for manufacturing feasibility of various genotypes/phenotypes such that risk of downstream changes is reduced. And, if a downstream change is indicated, there may be a possibility that the changed design already exists within an existing evolutionary population. As to delays, where a change is handled manually, it may introduce a number of days, which may be greater than a week (e.g., seven days or more). As such, an evolutionary approach may provide for improved bit design and manufacture. For example, in various instances, what previously may have taken a day or more may be performed in a matter of minutes.

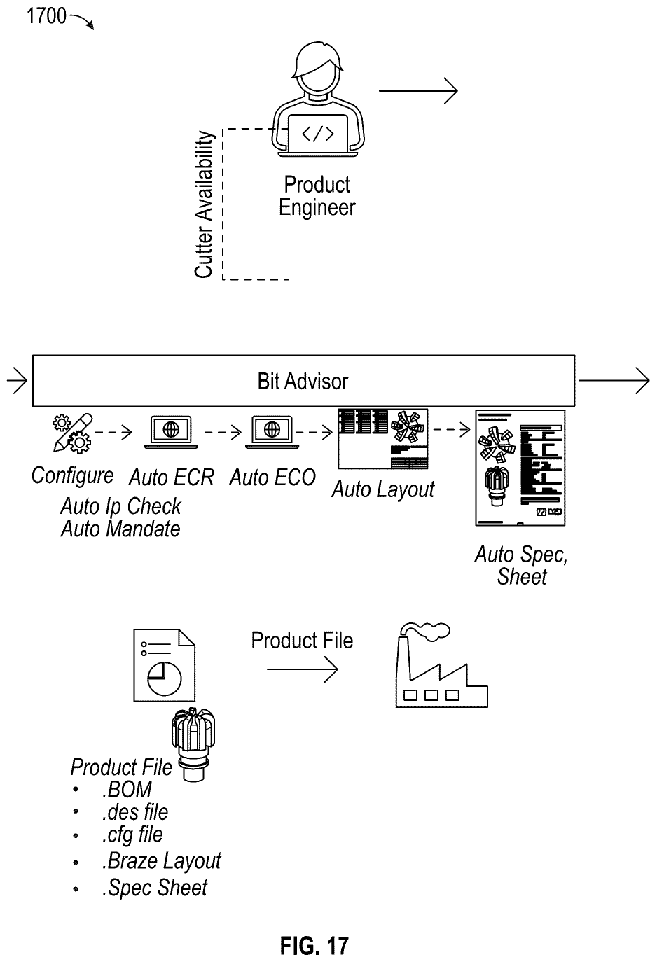

FIG. 17 shows an example of a workflow 1700 that includes various automated processes for generation of a product file suitable for manufacture of a bit.

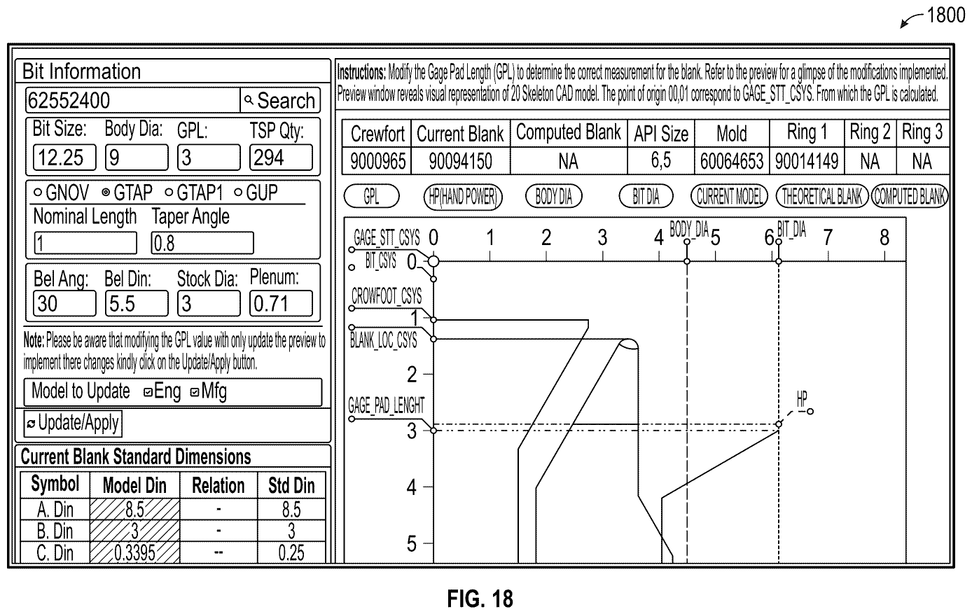

FIG. 18 shows an example of a GUI 1800 as to gauge pad length, which may be automated.

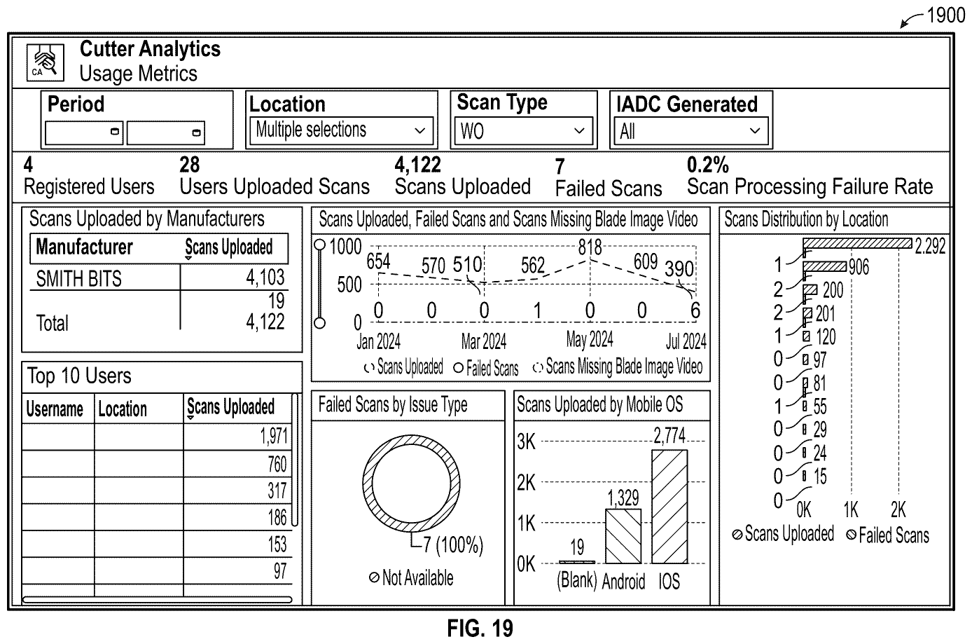

FIG. 19 shows an example of a GUI 1900 as to cutter analytics, which includes various graphics for comparisons, which may be with respect to time, location, etc.

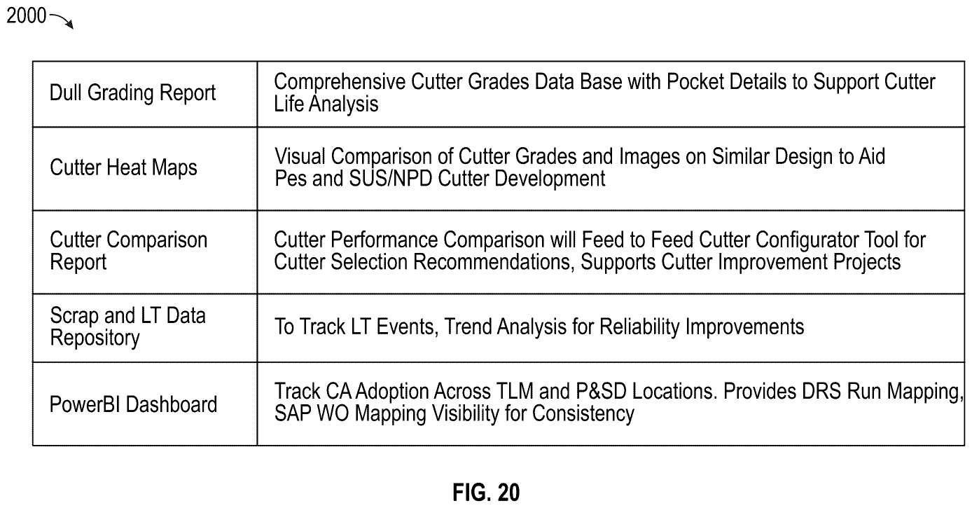

FIG. 20 shows an example of a GUI 2000 as to various example outputs, which may include dull grading cutter heat maps, cutter comparisons, scrap and LT data, etc.

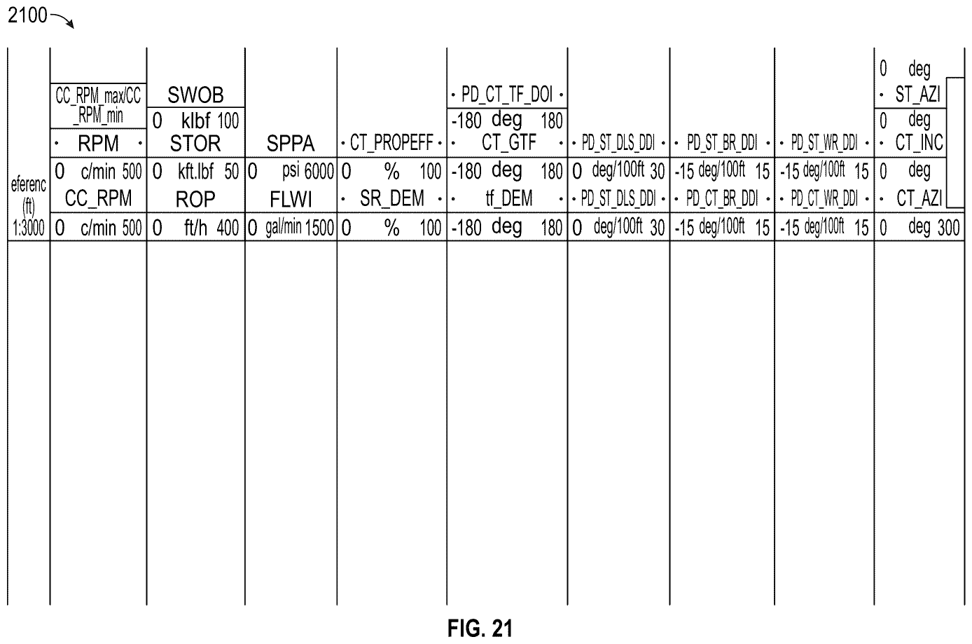

FIG. 21 shows an example of a GUI 2100 as to various examples of data that may be acquired during drilling operations that may be germane to bit performance (e.g., as part of a BHA, etc., in one or more formations, etc.). As shown, data may include RPM, WOB, TOR, ROP, SPPA, FLWI, along with other data. As explained, a control scheme may provide for control of a drawworks, mud pumps, a top drive, etc. In such an example, a controller or controllers may provide for control of drilling operations according to RPM, WOB, TOR, SPPA, FLWI, etc., which may provide for achieving a certain rate of penetration (ROP). As an example, a framework may provide for generation of one or more performance indicators (e.g., KPIs, etc.) using data where, for example, an MOO framework may provide for generation of one or more corresponding performance indicators that may be utilized in comparisons, for example, to select a bit design from a number of bit designs (e.g., using a Pareto approach, etc.).

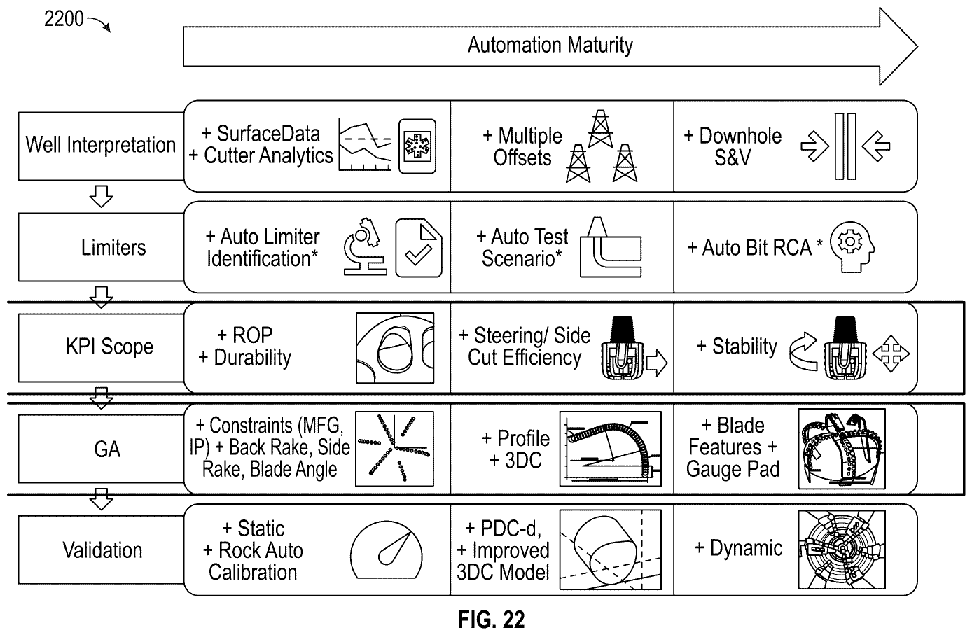

FIG. 22 shows an example of a GUI 2200 as to various examples of framework implementations. As shown, various aspects of well interpretation, limiters (e.g., constraints, etc.), performance indicator scope, evolutionary algorithms, and validation may provide for furthering automation. For example, a framework may provide for receipt of downhole shock and vibration data, auto bit RCA, stability analysis in multiple degrees of freedom, evolution as to blade features and/or gauge pad, and dynamic assessments as to validation.

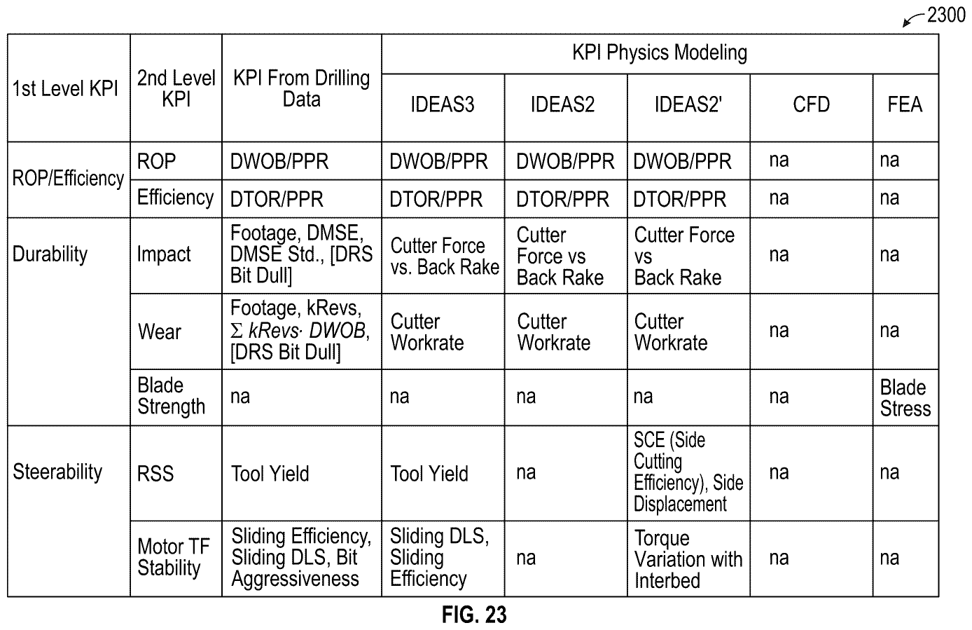

FIG. 23 shows an example of a GUI 2300 as to various examples of performance indicators. In the example GUI 2300, performance indicators as to ROP/efficiency, durability, and steerability are shown. As an example, a performance indicator may be engineered and may be considered an engineered feature as may be a result of feature engineering, as utilized in various machine learning techniques. As an example, one or more performance indicators may be utilized as features of a machine learning model, whether supervised, semi-supervised, or unsupervised in terms of learning. As an example, one or more engineered features may provide for improved performance of a machine learning model, improved utilization of data, improved training on lesser data, improved training via physics-based features, etc. In various instances, one or more engineered features may help to constrain operation of a machine learning model such that there is improved assurance of output being meaningful, physically, etc.

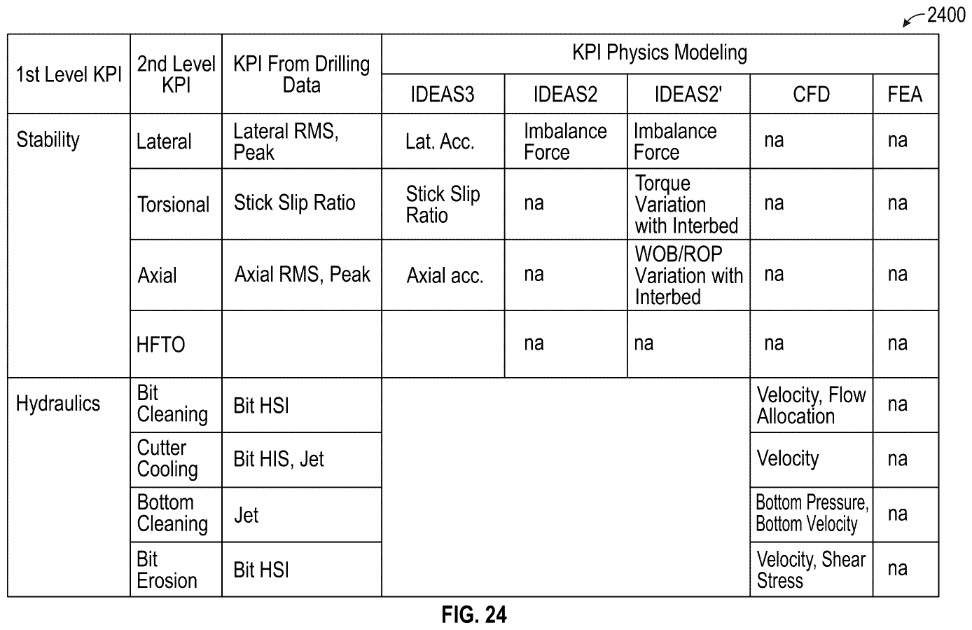

FIG. 24 shows an example of a GUI 2400 as to various examples of performance indicators. In the example GUI 2400, performance indicators as to stability and hydraulics are shown. As an example, one or more of the performance indicators of the GUI 2300 and/or the GUI 2400 may be utilized as one or more engineered features of one or more machine learning models.

As an example, one or more performance indicators may be utilized in a framework that may provide for bit design. For example, consider an evolutionary approach to bit design where MOO may be performed using one or more performance indicators. In such an example, a performance indicator may be generated via simulation and/or based at least in part on simulation results. In such an example, simulation results may be considered a type of raw data that can provide for generation of one or more performance indicators that may provide for improved MOO operation. As an example, a GUI may be provided for selection of one or more performance indicators, which may be for one or more formation types. In such an example, one or more selected performance indicators may be utilized as part of an MOO operation. In such an example, one or more simulators may be selected based at least in part on performance indicator selection such that one or more performance indicators may be computed and fed to an MOO component of a framework (e.g., as an array, a vector, etc.).

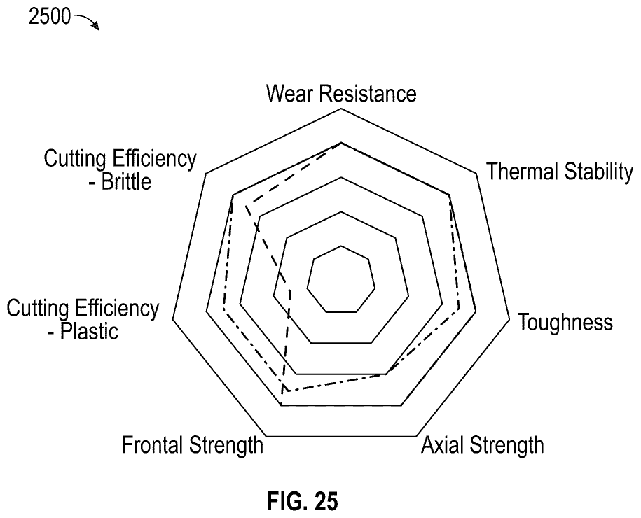

FIG. 25 shows an example of a GUI 2500 as to a comparison between two scenarios, which may be for two different bit designs.

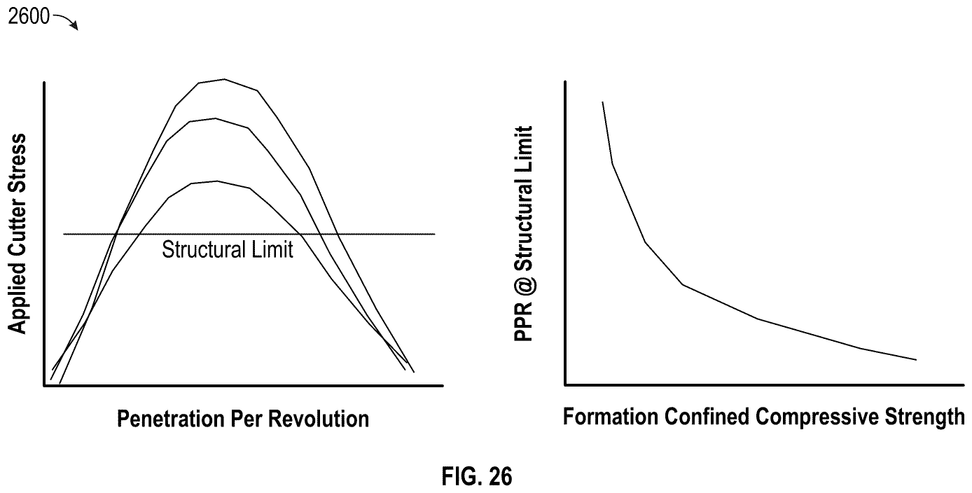

FIG. 26 shows an example of a GUI 2600 as to example performance indicators. As an example, a performance indicator may provide for a measure of efficiency (e.g., downhole WOB/penetration per revolution (PPR)). As an example, a performance indicator may provide for a measure of durability (e.g., cutter integrity as a function of force).

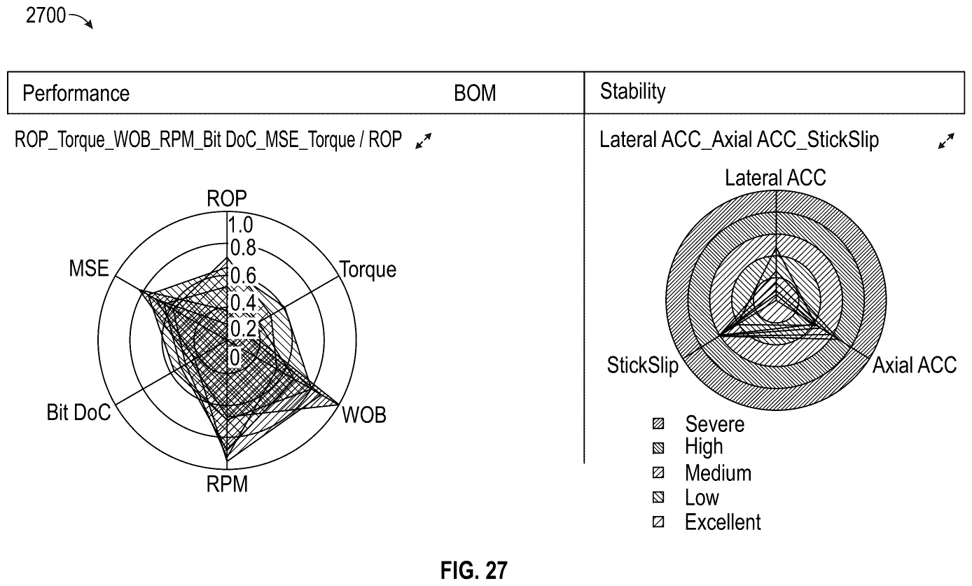

FIG. 27 shows an example of a GUI 2700 as to example performance indicators for performance and for stability. As shown, performance indicators for performance may include ROP, MSE, torque, WOB, RPM, and bit DoC (DOC). As shown, performance indicators for stability may include lateral acceleration, stick-slip, and axial acceleration. As an example, color coding may be utilized, for example, to rate one or more performance indicators.

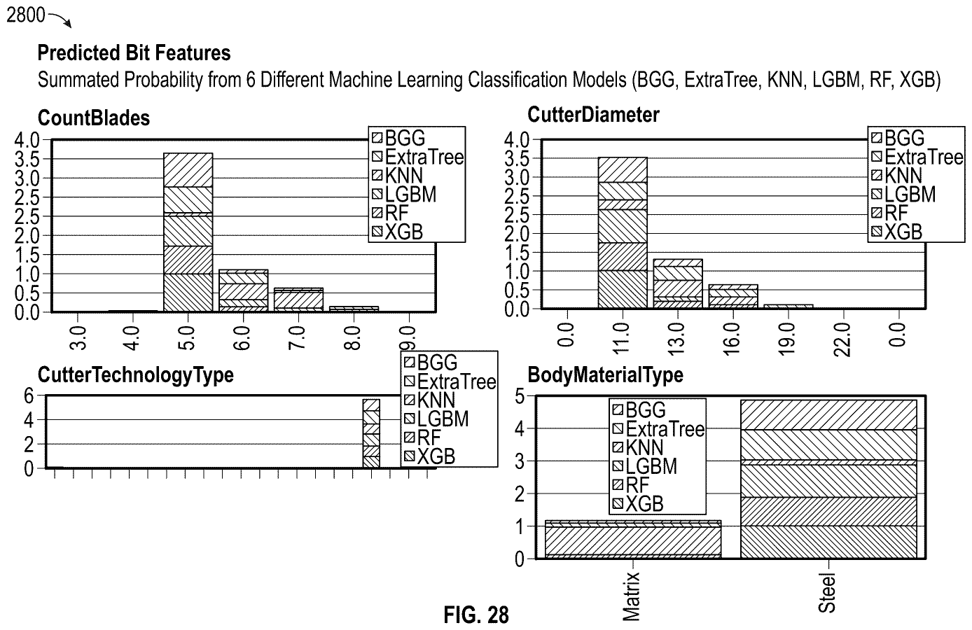

FIG. 28 shows an example of a GUI 2800 as to example output of predicted bit features, utilizing one or more types of prediction technologies. For example, consider use of BGG, extratree, KNN, LGBM, RF, XGB, etc. As shown, one or more ML models may be utilized to predict one or more of blade count, cutter diameter, cutter technology type, body material type, etc.

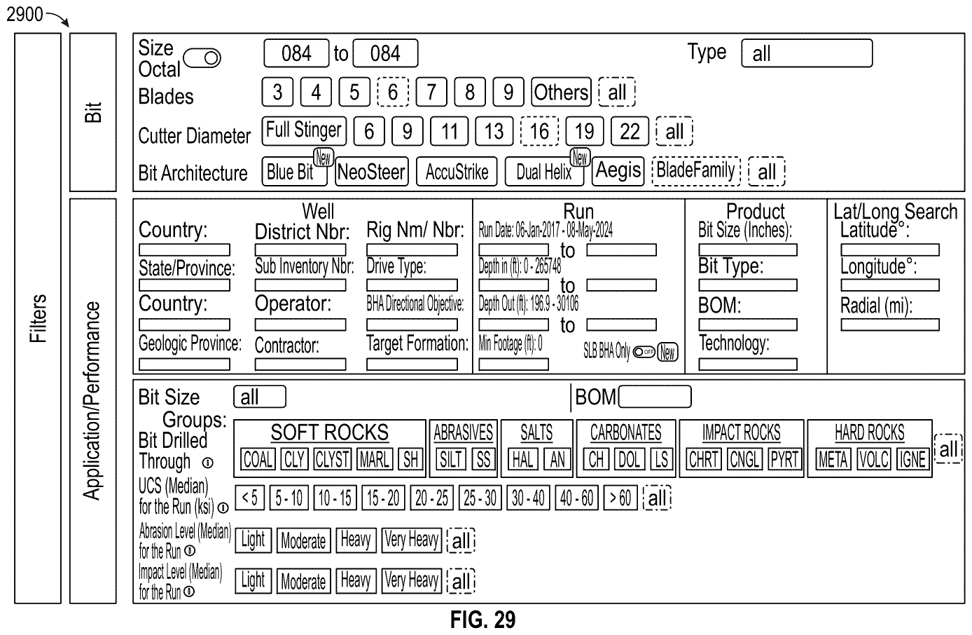

FIG. 29 shows an example of a GUI 2900 as to examples of input filters for a bit, application of a bit, performance of a bit, etc. As shown, such input filters may be for blade number, cutter diameter, bit architecture, well, run, product, bit size, formation types, lithology, UCS, abrasion level, impact level, etc.

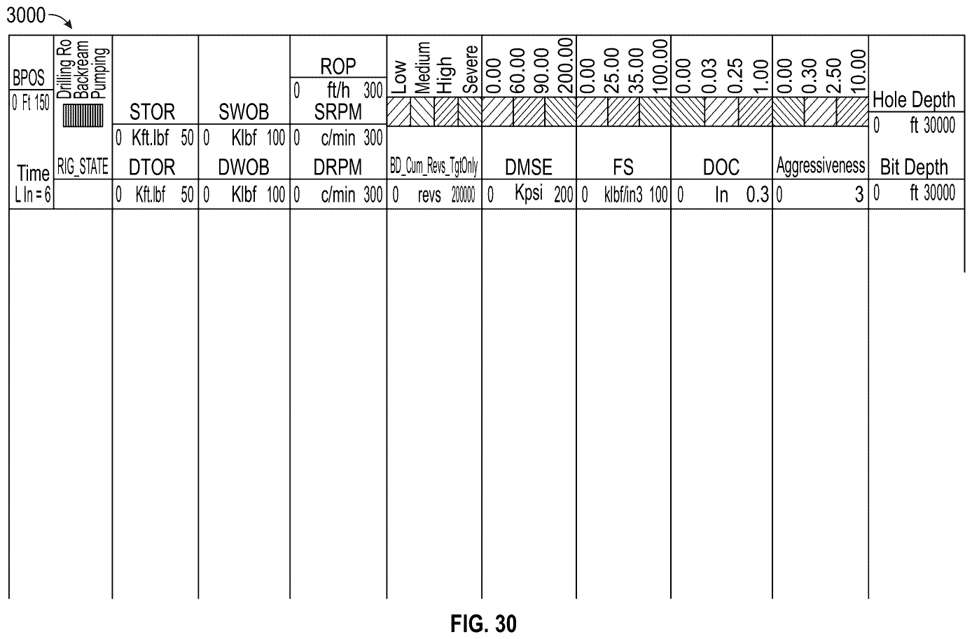

FIG. 30 shows an example of a GUI 3000 as to examples of output for drilling operations. As shown, the GUI 3000 may include one or more performance indicators to assist in control of drilling operations, assessment of drilling operations, training of one or more ML models, etc. As shown, one or more of DMSE, FS, DOC, aggressiveness, etc., may be included. As indicated, states of drilling may be provided along with block position (BPOS). As indicated, measurements may include downhole measurements and surface measurements (e.g., TOR, WOB, RPM, etc.).

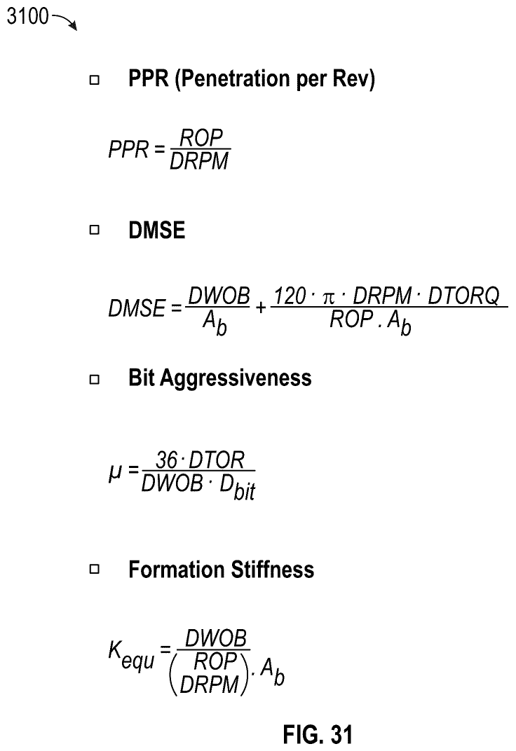

FIG. 31 shows an example of a GUI 3100 as to examples of performance indicators as to PPR, DMSE, bit aggressiveness, and formation stiffness, as may be relevant to drilling operations.

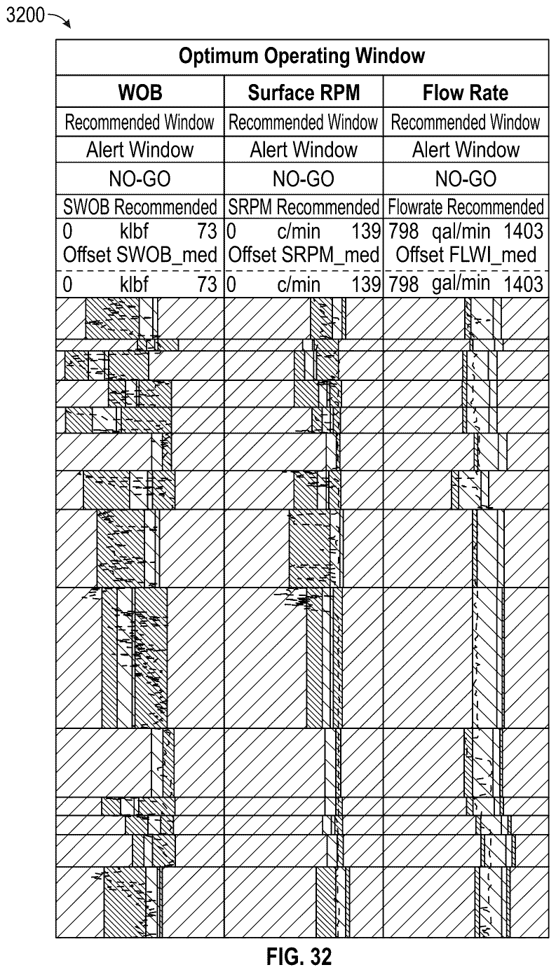

FIG. 32 shows an example of a GUI 3200 as to examples of optimum operating window values for WOB, surface RPM, and flow rate, which may be presented with respect to depth for one or more formation types (see thick horizontal lines that may distinguish layer boundaries, etc.). As explained, a framework may provide for integrating control information from offset wells to generate a bit design along with control information for utilization of a bit according to the bit design. For example, bit design may take into account performance for one or more formation types to be drilled. In such an example, control information as to performance may be associated with a bit design where the control information may be in a digital form for receipt by a controller. As an example, a controller may be an autodriller that may operate at one or more levels of automation, where a higher level of automation may demand less human attention. As an example, where an alert window is relatively wide, a level of automation may be higher as exceeding the alert window during drilling may be of a relatively low risk.

As an example, a bit design framework may provide for improved automation during drilling operations. As explained, where a bit design is generated using information relevant to drilling operations at a site, the bit design may be linked to one or more drilling parameters, which may be specified with respect to depth (e.g., measured depth, true vertical depth, etc.), formation type, etc. As an example, an optimal operating window (OOW) may be an output of a bit design framework. For example, consider a bit design framework that can provide for bit design optimization such that an optimal design may be selected for bit selection and/or bit manufacture where that bit may be utilized for drilling operations using one or more controllers that are programmed to operate according to an OOW. In such an approach, bit design and control may be generated simultaneously via a bit design framework. As an example, an OOW may be in a digital form, for example, as a file, to be received by a controller or controllers at a site or sites (e.g., where one bit design is to be utilized for multiple sites within a region, etc.).

As an example, one or more performance indicators may be selected, generated, etc. As explained, a performance indicator may be a feature such as, for example, an engineered feature. As an example, an AI assisted bit design framework may provide for use of performance indicators that may help to unify design aspects across various structures such as shapes, cutter type, cutting structure, etc. As an example, such an approach may help to harmonize for purposes of collaboration. As an example, one or more GUIs may provide for interactions with a framework for feature generation, selection, etc., which may be in a manner suited for use with one or more types of ML models. As an example, data and/or features may be manufacturing related, use related, laboratory testing related, etc. As an example, laboratory testing aspects may include pre and/or post use aspects. For example, consider a photometric approach to laboratory analysis where a bit or one or more portions thereof may be graded using one or more photometric techniques. In such an example, grading may pertain to dulling of one or more cutters, stress, cracking, chipping, etc., which may be linked to cutter performance, bit performance, etc.

As an example, one or more aspects of a bit design framework may utilize one or more types of image analysis techniques, which may include one or more machine learning techniques. For example, consider an unsupervised CNN-based approach that may apply an ML architecture such as the U-Net architecture, which includes an encoder and a decoder with links. As explained, one or more types of ML model-based approaches may be utilized by a framework.

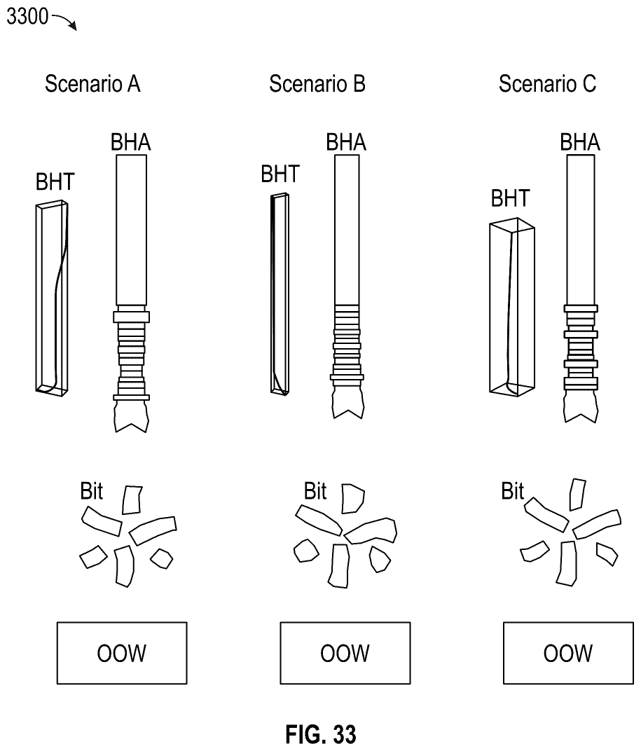

FIG. 33 shows an example of a GUI 3300 as to examples of scenarios that may each include borehole trajectory, BHA, bit, and optimum operating window (OOW). As an example, a bit design framework may be implemented as part of an overarching optimization as to various factors, which may include borehole trajectory and BHA, in addition to bit design. As explained, a bit design framework may provide for output of information relevant to control of field equipment during drilling operations.

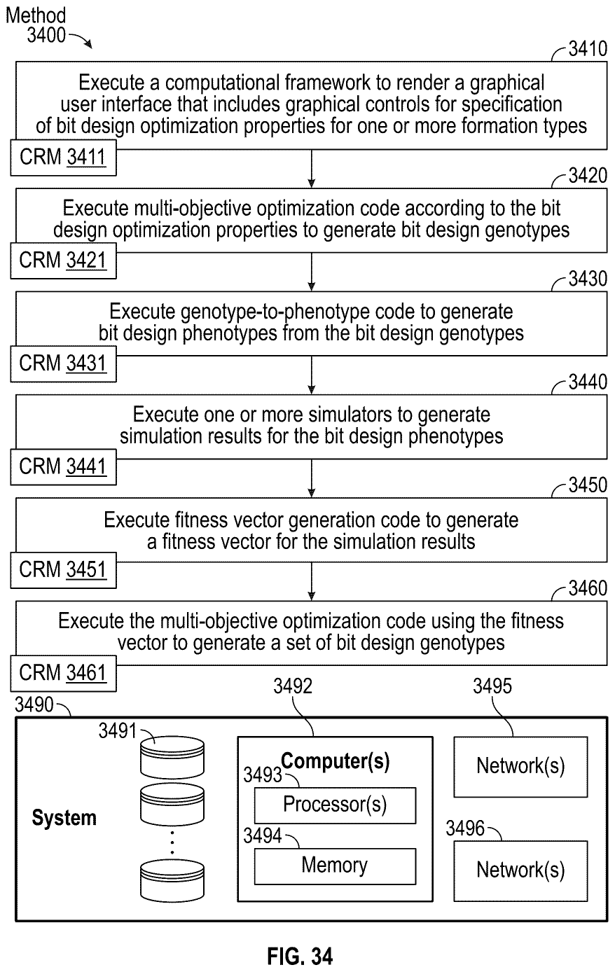

FIG. 34 shows an example of a method 3400 that includes an execution block 3410 for executing a computational framework to render a graphical user interface to a display that includes graphical controls for specification of bit design optimization properties for one or more formation types; an execution block 3420 for executing multi-objective optimization code according to the bit design optimization properties to generate bit design genotypes; an execution block 3430 for executing genotype-to-phenotype code to generate bit design phenotypes from the bit design genotypes; an execution block 3440 for executing one or more simulators to generate simulation results for the bit design phenotypes; an execution block 3450 for executing fitness vector generation code to generate a fitness vector for the simulation results; and an execution block 3460 for executing the multi-objective optimization code using the fitness vector to generate a set of bit design genotypes.

FIG. 34 also shows various computer-readable media (CRM) blocks 3411, 3421, 3431, 3441, 3451, and 3461. Such blocks may include instructions that are executable by one or more processors, which may be one or more processors of a computational framework, a system, a computer, etc. A computer-readable medium may be a computer-readable storage medium that is not a signal, not a carrier wave and that is non-transitory. For example, a computer-readable medium may be a physical memory component that may store information in a digital format.

In the example of FIG. 34, a system 3490 includes one or more information storage devices 3491, one or more computers 3492, one or more networks 3495 and instructions 3496. As to the one or more computers 3492, each computer may include one or more processors (e.g., or processing cores) 3493 and a memory 3494 for storing the instructions 3496, for example, executable by at least one of the one or more processors. As an example, a computer may include one or more network interfaces (e.g., wired or wireless), one or more graphics cards, a display interface (e.g., wired or wireless), etc. The system 3490 may be specially configured to perform one or more portions of the method 3400 of FIG. 34.

As an example, a framework may employ one or more machine learning models. As to types of machine learning models, consider one or more of a support vector machine (SVM) model, a k-nearest neighbors (KNN) model, an ensemble classifier model, a neural network (NN) model, etc. As an example, a machine learning model may be a deep learning model (e.g., deep Boltzmann machine, deep belief network, convolutional neural network, stacked auto-encoder, etc.), an ensemble model (e.g., random forest, gradient boosting machine, bootstrapped aggregation, AdaBoost, stacked generalization, gradient boosted regression tree, etc.), a neural network model (e.g., radial basis function network, perceptron, back-propagation, Hopfield network, etc.), a regularization model (e.g., ridge regression, least absolute shrinkage and selection operator, elastic net, least angle regression), a rule system model (e.g., cubist, one rule, zero rule, repeated incremental pruning to produce error reduction), a regression model (e.g., linear regression, ordinary least squares regression, stepwise regression, multivariate adaptive regression splines, locally estimated scatterplot smoothing, logistic regression, etc.), a Bayesian model (e.g., naïve Bayes, average on-dependence estimators, Bayesian belief network, Gaussian naïve Bayes, multinomial naïve Bayes, Bayesian network), a decision tree model (e.g., classification and regression tree, iterative dichotomiser 3, C4.5, C5.0, chi-squared automatic interaction detection, decision stump, conditional decision tree, M5), a dimensionality reduction model (e.g., principal component analysis, partial least squares regression, Sammon mapping, multidimensional scaling, projection pursuit, principal component regression, partial least squares discriminant analysis, mixture discriminant analysis, quadratic discriminant analysis, regularized discriminant analysis, flexible discriminant analysis, linear discriminant analysis, etc.), an instance model (e.g., k-nearest neighbor, learning vector quantization, self-organizing map, locally weighted learning, etc.), a clustering model (e.g., k-means, k-medians, expectation maximization, hierarchical clustering, etc.), etc.

As an example, a machine model, which may be a machine learning model (ML model), may be built using a computational framework with a library, a toolbox, etc., such as, for example, those of the MATLAB framework (MathWorks, Inc., Natick, Massachusetts). The MATLAB framework includes a toolbox that provides supervised and unsupervised machine learning algorithms, including support vector machines (SVMs), boosted and bagged decision trees, k-nearest neighbor (KNN), k-means, k-medoids, hierarchical clustering, Gaussian mixture models, and hidden Markov models. Another MATLAB framework toolbox is the Deep Learning Toolbox (DLT), which provides a framework for designing and implementing deep neural networks with algorithms, pretrained models, and apps. The DLT provides convolutional neural networks (ConvNets, CNNs) and long short-term memory (LSTM) networks to perform classification and regression on image, time-series, and text data. The DLT includes features to build network architectures such as generative adversarial networks (GANs) and Siamese networks using custom training loops, shared weights, and automatic differentiation. The DLT provides for model exchange various other frameworks.

As an example, the TENSORFLOW framework (Google LLC, Mountain View, CA) may be implemented, which is an open-source software library for dataflow programming that includes a symbolic math library, which may be implemented for machine learning applications that may include neural networks. As an example, the CAFFE framework may be implemented, which is a DL framework developed by Berkeley AI Research (BAIR) (University of California, Berkeley, California). As another example, consider the SCIKIT platform (e.g., scikit-learn), which utilizes the PYTHON programming language. As an example, a framework such as the APOLLO AI framework may be utilized (APOLLO.AI GmbH, Germany). As an example, a framework such as the PYTORCH framework may be utilized (Facebook AI Research Lab (FAIR), Facebook, Inc., Menlo Park, California).

As an example, a training method may include various actions that may operate on a dataset to train a ML model. As an example, a dataset may be split into training data and test data where test data may provide for evaluation. A method may include cross-validation of parameters and best parameters, which may be provided for model training.

The TENSORFLOW framework may run on multiple CPUs and GPUs (with optional CUDA (NVIDIA Corp., Santa Clara, California) and SYCL (The Khronos Group Inc., Beaverton, Oregon) extensions for general-purpose computing on graphics processing units (GPUs)). TENSORFLOW is available on 64-bit LINUX, MACOS (Apple Inc., Cupertino, California), WINDOWS (Microsoft Corp., Redmond, Washington), and mobile computing platforms including ANDROID (Google LLC, Mountain View, California) and IOS (Apple Inc.) operating system-based platforms.

TENSORFLOW computations may be expressed as stateful dataflow graphs; noting that the name TENSORFLOW derives from the operations that such neural networks perform on multidimensional data arrays. Such arrays may be referred to as “tensors”.

As an example, a device may utilize TENSORFLOW LITE (TFL) or another type of lightweight framework. TFL is a set of tools that enables on-device machine learning where models may run on mobile, embedded, and IoT devices. TFL is optimized for on-device machine learning, by addressing latency (no round-trip to a server), privacy (no personal data leaves the device), connectivity (Internet connectivity is demanded), size (reduced model and binary size) and power consumption (e.g., efficient inference and a lack of network connections). TFL includes multiple platform support, covering ANDROID and iOS devices, embedded LINUX, and microcontrollers and diverse language support, which includes JAVA, SWIFT, Objective-C, C++, and PYTHON. TFL provides for high performance, with hardware acceleration and model optimization.

As an example, a method may include executing a computational framework to render a graphical user interface to a display that includes graphical controls for specification of bit design optimization properties for one or more formation types; executing multi-objective optimization code according to the bit design optimization properties to generate bit design genotypes; executing genotype-to-phenotype code to generate bit design phenotypes from the bit design genotypes; executing one or more simulators to generate simulation results for the bit design phenotypes; executing fitness vector generation code to generate a fitness vector for the simulation results; and executing the multi-objective optimization code using the fitness vector to generate a set of bit design genotypes. In such an example, the method may include executing embryogeny code to assess the bit design phenotypes. In such an example, the method may include excluding one or more of the bit design phenotypes prior to executing the one or more simulators and/or assessing manufacturability of each of the bit design phenotypes.

As an example, a set of bit design genotypes may include a corresponding set of control instructions. In such an example, a method may include controlling drilling operations for a bit specified according to one of a number of bit design genotypes of a set of bit design genotypes using corresponding control instructions of a set of control instructions.

As an example, a multi-objective optimization code may include a genetic algorithm code. In such an example, the genetic algorithm code may include a non-dominated sorting genetic algorithm (NSGA) code.

As an example, a set of bit design genotypes may be or include a Pareto set.

As an example, one or more simulators for use by a framework and/or within a workflow, may include at least one drilling simulator, at least one computational fluid dynamics simulator, and/or one or more other types of simulators.

As an example, a fitness vector may indicate optimality of each of a number of bit design phenotypes according to corresponding simulation results of simulation results.

As an example, a method may include receiving one or more adjusted bit design optimization properties and automatically adjusting executing of a multi-objective optimization code.

As an example, one or more formation types may include at least two different formation types.

As an example, a method may include generating graphics for bit design optimization properties for a set of bit design genotypes. In such an example, the graphics may include indicia of bit design performance for more than one formation type. As an example, a method may include, responsive to receipt of a GUI actuation, selecting one of a number of bit design genotypes of a set of bit design genotypes. In such an example, the method may include, responsive to the selecting, generating a digital file for manufacture of a bit according to the selected bit design genotype. In such an example, one or more types of manufacturing equipment may be controlled according to the digital file (e.g., digital data, instructions, etc., in a digital form, etc.).

As an example, a system may include a processor; a memory accessible by the processor; and processor-executable instructions stored in the memory that are executable to instruct the system to: render a graphical user interface to a display that includes graphical controls for specification of bit design optimization properties for one or more formation types; execute multi-objective optimization code according to the bit design optimization properties to generate bit design genotypes; execute genotype-to-phenotype code to generate bit design phenotypes from the bit design genotypes; execute one or more simulators to generate simulation results for the bit design phenotypes; execute fitness vector generation code to generate a fitness vector for the simulation results; and execute the multi-objective optimization code using the fitness vector to generate a set of bit design genotypes.

As an example, one or more non-transitory computer-readable storage media may include computer-executable instructions executable to instruct a computing system to: render a graphical user interface to a display that includes graphical controls for specification of bit design optimization properties for one or more formation types; execute multi-objective optimization code according to the bit design optimization properties to generate bit design genotypes; execute genotype-to-phenotype code to generate bit design phenotypes from the bit design genotypes; execute one or more simulators to generate simulation results for the bit design phenotypes; execute fitness vector generation code to generate a fitness vector for the simulation results; and execute the multi-objective optimization code using the fitness vector to generate a set of bit design genotypes.

As an example, a method may be implemented in part using computer-readable media (CRM), for example, as a module, a block, etc. that include information such as instructions suitable for execution by one or more processors (or processor cores) to instruct a computing device or system to perform one or more actions. As an example, a single medium may be configured with instructions to allow for, at least in part, performance of various actions of a method. As an example, a computer-readable medium (CRM) may be a computer-readable storage medium (e.g., a non-transitory medium) that is not a carrier wave. As an example, a computer-program product may include instructions suitable for execution by one or more processors (or processor cores) where the instructions may be executed to implement at least a portion of a method or methods.

According to an embodiment, one or more computer-readable media may include computer-executable instructions to instruct a computing system to output information for controlling a process. For example, such instructions may provide for output to sensing process, an injection process, drilling process, an extraction process, an extrusion process, a pumping process, a heating process, a design process, etc.

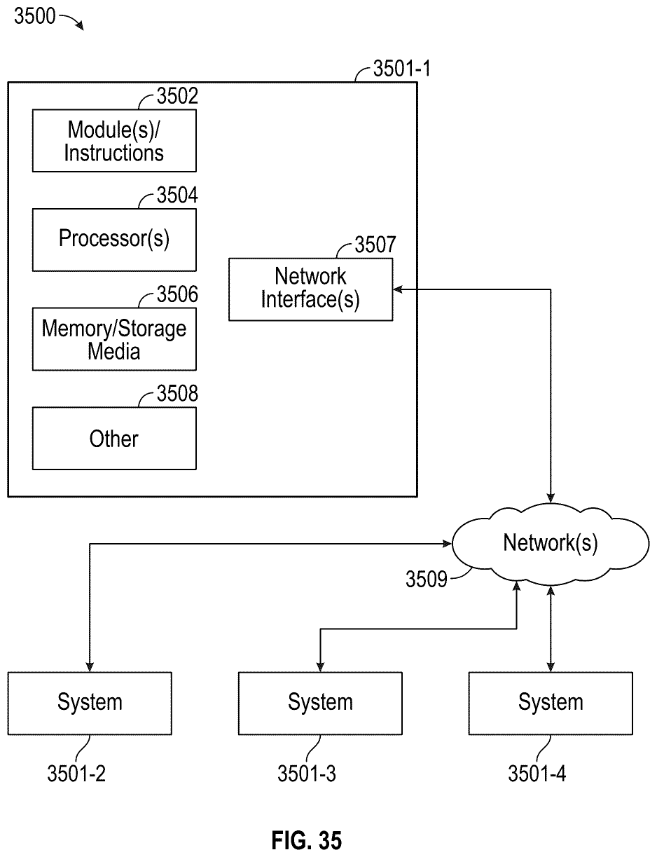

In some embodiments, a method or methods may be executed by a computing system. FIG. 35 shows an example of a system 3500 that may include one or more computing systems 3501-1, 3501-2, 3501-3 and 3501-4, which may be operatively coupled via one or more networks 3509, which may include wired and/or wireless networks.

As an example, a system may include an individual computer system or an arrangement of distributed computer systems. In the example of FIG. 35, the computer system 3501-1 may include one or more modules 3502, which may be or include processor-executable instructions, for example, executable to perform various tasks (e.g., receiving information, requesting information, processing information, simulation, outputting information, etc.).

As an example, a module may be executed independently, or in coordination with, one or more processors 3504, which is (or are) operatively coupled to one or more storage media 3506 (e.g., via wire, wirelessly, etc.). As an example, one or more of the one or more processors 3504 may be operatively coupled to at least one of one or more network interface 3507. In such an example, the computer system 3501-1 may transmit and/or receive information, for example, via the one or more networks 3509 (e.g., consider one or more of the Internet, a private network, a cellular network, a satellite network, etc.). As shown, one or more other components 3508 may be included in the computer system 3501-1.

As an example, the computer system 3501-1 may receive from and/or transmit information to one or more other devices, which may be or include, for example, one or more of the computer systems 3501-2, etc. A device may be located in a physical location that differs from that of the computer system 3501-1. As an example, a location may be, for example, a processing facility location, a data center location (e.g., server farm, etc.), a rig location, a wellsite location, a downhole location, etc.

As an example, a processor may be or include a microprocessor, microcontroller, processor module or subsystem, programmable integrated circuit, programmable gate array, or another control or computing device.

As an example, the storage media 3506 may be implemented as one or more computer-readable or machine-readable storage media. As an example, storage may be distributed within and/or across multiple internal and/or external enclosures of a computing system and/or additional computing systems.

As an example, a storage medium or storage media may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLUERAY disks, or other types of optical storage, or other types of storage devices.

As an example, a storage medium or media may be located in a machine running machine-readable instructions, or located at a remote site from which machine-readable instructions may be downloaded over a network for execution.

As an example, various components of a system such as, for example, a computer system, may be implemented in hardware, software, or a combination of both hardware and software (e.g., including firmware), including one or more signal processing and/or application specific integrated circuits.

As an example, a system may include a processing apparatus that may be or include a general-purpose processors or application specific chips (e.g., or chipsets), such as ASICs, FPGAs, PLDs, or other appropriate devices.

As an example, a device may be a mobile device that includes one or more network interfaces for communication of information. For example, a mobile device may include a wireless network interface (e.g., operable via IEEE 802.11, ETSI GSM, BLUETOOTH, satellite, etc.). As an example, a mobile device may include components such as a main processor, memory, a display, display graphics circuitry (e.g., optionally including touch and gesture circuitry), a SIM slot, audio/video circuitry, motion processing circuitry (e.g., accelerometer, gyroscope), wireless LAN circuitry, smart card circuitry, transmitter circuitry, GPS circuitry, and a battery. As an example, a mobile device may be configured as a cell phone, a tablet, etc. As an example, a method may be implemented (e.g., wholly or in part) using a mobile device. As an example, a system may include one or more mobile devices.

As an example, a system may be a distributed environment, for example, a so-called “cloud” environment where various devices, components, etc. interact for purposes of data storage, communications, computing, etc. As an example, a device or a system may include one or more components for communication of information via one or more of the Internet (e.g., where communication occurs via one or more Internet protocols), a cellular network, a satellite network, etc. As an example, a method may be implemented in a distributed environment (e.g., wholly or in part as a cloud-based service).

As an example, information may be input from a display (e.g., consider a touchscreen), output to a display or both. As an example, information may be output to a projector, a laser device, a printer, etc. such that the information may be viewed. As an example, information may be output stereographically or holographically. As to a printer, consider a 2D or a 3D printer. As an example, a 3D printer may include one or more substances that may be output to construct a 3D object. For example, data may be provided to a 3D printer to construct a 3D representation of a subterranean formation. As an example, layers may be constructed in 3D (e.g., horizons, etc.), geobodies constructed in 3D, etc. As an example, holes, fractures, etc., may be constructed in 3D (e.g., as positive structures, as negative structures, etc.).

Although only a few examples have been described in detail above, those skilled in the art will readily appreciate that many modifications are possible in the examples. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

What is claimed is:

1. A method comprising:
executing a computational framework to render a graphical user interface to a display that comprises graphical controls for specification of bit design optimization properties for one or more formation types;
executing multi-objective optimization code according to the bit design optimization properties to generate bit design genotypes;
executing genotype-to-phenotype code to generate bit design phenotypes from the bit design genotypes;
executing one or more simulators to generate simulation results for the bit design phenotypes;
executing fitness vector generation code to generate a fitness vector for the simulation results; and
executing the multi-objective optimization code using the fitness vector to generate a set of bit design genotypes.

2. The method of claim 1, comprising executing embryogeny code to assess the bit design phenotypes.

3. The method of claim 2, comprising excluding one or more of the bit design phenotypes prior to executing the one or more simulators.

4. The method of claim 2, wherein to assess comprises assessing manufacturability of each of the bit design phenotypes.

5. The method of claim 1, wherein the set of bit design genotypes comprises a corresponding set of control instructions.

6. The method of claim 5, comprising controlling drilling operations for a bit specified according to one of the bit design genotypes of the set of bit design genotypes using the corresponding control instructions of the set of control instructions.

7. The method of claim 1, wherein the multi-objective optimization code comprises genetic algorithm code.

8. The method of claim 7, wherein the genetic algorithm code comprises a non-dominated sorting genetic algorithm (NSGA) code.

9. The method of claim 1, wherein the set of bit design genotypes comprises a Pareto set.

10. The method of claim 1, wherein the one or more simulators comprise at least one drilling simulator.

11. The method of claim 1, wherein the one or more simulators comprise at least one computational fluid dynamics simulator.

12. The method of claim 1, wherein the fitness vector indicates optimality of each of the bit design phenotypes according to corresponding simulation results of the simulation results.

13. The method of claim 1, comprising receiving one or more adjusted bit design optimization properties and automatically adjusting the executing of the multi-objective optimization code.

14. The method of claim 1, wherein the one or more formation types comprise at least two different formation types.

15. The method of claim 1, comprising generating graphics for the bit design optimization properties for the set of bit design genotypes.

16. The method of claim 15, wherein the graphics comprise indicia of bit design performance for more than one formation type.

17. The method of claim 15, comprising, responsive to receipt of a GUI actuation, selecting one of the bit design genotypes of the set of bit design genotypes.

18. The method of claim 17, comprising, responsive to the selecting, generating a digital file for manufacture of a bit according to the selected bit design genotype.

19. A system comprising:
a processor;
a memory accessible by the processor; and
processor-executable instructions stored in the memory that are executable to instruct the system to:
render a graphical user interface to a display that comprises graphical controls for specification of bit design optimization properties for one or more formation types;
execute multi-objective optimization code according to the bit design optimization properties to generate bit design genotypes;
execute genotype-to-phenotype code to generate bit design phenotypes from the bit design genotypes;
execute one or more simulators to generate simulation results for the bit design phenotypes;
execute fitness vector generation code to generate a fitness vector for the simulation results; and
execute the multi-objective optimization code using the fitness vector to generate a set of bit design genotypes.

20. One or more non-transitory computer-readable storage media comprising computer-executable instructions executable to instruct a computing system to:
render a graphical user interface to a display that comprises graphical controls for specification of bit design optimization properties for one or more formation types;
execute multi-objective optimization code according to the bit design optimization properties to generate bit design genotypes;
execute genotype-to-phenotype code to generate bit design phenotypes from the bit design genotypes;
execute one or more simulators to generate simulation results for the bit design phenotypes;
execute fitness vector generation code to generate a fitness vector for the simulation results; and
execute the multi-objective optimization code using the fitness vector to generate a set of bit design genotypes.
